(19) United States
(12) Patent Application Publication
(10) Pub. No.: US 2012/0254592 A1
(43) Pub. Date: Oct. 4, 2012

(54) SYSTEMS, APPARATUSES, AND METHODS FOR EXPANDING A MEMORY SOURCE INTO A DESTINATION REGISTER AND COMPRESSING A SOURCE REGISTER INTO A DESTINATION MEMORY LOCATION

(76) Inventors: Jesus Corbal San Adrian, Barcelona (ES); Roger Espasa Sans, Mallorca (ES); Robert C. Valentine, Kiryat Tivon (IL); Santiago Galan Duran, Nolins De Rei (ES); Jeffrey G. Wiedemeier, Austin, TX (US); Sridhar Samudrala, Austin, TX (US); Milind Baburao Girkar, Sunnyvale, CA (US); Andrew Thomas Forsyth, Kirkland, WA (US); Victor W. Lee, Santa Clara, CA (US)

(21) Appl. No.: 13/078,896

(22) Filed: Apr. 1, 2011

(51) Int. Cl. G06F 9/30

(52) U.S. Cl. 712/205; 712/E09.016

(57) ABSTRACT

Embodiments of systems, apparatuses, and methods for performing an expand and/or compress instruction in a computer processor are described. In some embodiments, the execution of an expand instruction causes the selection of elements from a source that are to be sparsely stored in a destination based on values of the writemask and store each selected data element of the source as a sparse data element into a destination location, wherein the destination locations correspond to each writemask bit position that indicates that the corresponding data element of the source is to be stored.

### FIELD OF INVENTION

The field of invention relates generally to computer processor architecture, and, more specifically, to instructions which when executed cause a particular result.

### BACKGROUND

There are several ways to improve memory utilization by manipulating data-structure layout. For certain algorithms, like 3D transformations and lighting, there are two basic ways of arranging the vertex data. The traditional method is the array of structures (AoS) arrangement, with a structure for each vertex. Another arranges the data in an array for each coordinate, in a structure of arrays (SoA) arrangement.

There are two options for computing data in AoS format: perform operation on the data as it stands in an AoS arrangement or re-arrange it (swizzle it) into a SoA arrangement. Performing SIMD operations on the original AoS arrangement can require more calculations and some of the operations do not take advantage of all of the SIMD elements available. Therefore, this option is generally less efficient.

The SoA arrangement allows more efficient use of the parallelism of the Single Instruction, Multiple Data (SIMD) technologies because the data is ready for computation in a more optimal vertical manner. In contrast, computing directly on AoS data can lead to horizontal operations that consume SIMD execution slots but produce only a single scalar result, as shown by the many “don't-care” (DC) slots in the previous code sample.

With the advent of the SIMD technologies, the choice of data organization becomes more important and should be carefully based on the operations to be performed on the data. In some applications, traditional data arrangements may not lead to the maximum performance. Application developers have been encouraged to explore different data arrangements and data segmentation policies for efficient computation. This may mean using a combination of AoS, SoA, and even Hybrid SoA in a given application.

### BRIEF DESCRIPTION OF THE DRAWINGS

The present invention is illustrated by way of example and not limitation in the figures of the accompanying drawings, in which like references indicate similar elements and in which:

An example of an expand instruction's execution is illustrated in FIG. 1.

FIG. 2 illustrates an example of an expand instruction's execution with a register operand as the source.

FIG. 3 illustrates an example of pseudo code for executing an expand instruction.

FIG. 4 illustrates an embodiment of the use of an expand instruction in a processor.

FIG. 5 illustrates an embodiment of a method for processing a expand instruction.

FIG. 6 illustrates an example of a compress instruction's execution in a processor.

FIG. 7 illustrates another example of a compress instruction's execution in a processor.

FIG. 8 illustrates an example of pseudo code for executing an expand instruction.

FIG. 9 illustrates an embodiment of the use of a compress instruction in a processor.

FIG. 10 illustrates an example of an embodiment of a method for processing a compress instruction.

FIG. 11A is a block diagram illustrating a generic vector friendly instruction format and class A instruction templates thereof according to embodiments of the invention.

FIG. 11B is a block diagram illustrating the generic vector friendly instruction format and class B instruction templates thereof according to embodiments of the invention.

FIG. 12 is a block diagram illustrating an exemplary specific vector friendly instruction format according to embodiments of the invention.

FIG. 13 is a block diagram of a register architecture according to one embodiment of the invention.

FIG. 14A is a block diagram of a single CPU core, along with its connection to the on-die interconnect network and with its local subset of the level 2 (L2) cache, according to embodiments of the invention.

FIG. 14B is an exploded view of part of the CPU core in FIG. 14A according to embodiments of the invention.

FIG. 15 is a block diagram illustrating an exemplary out-of-order architecture according to embodiments of the invention.

FIG. 16 is a block diagram of a system in accordance with one embodiment of the invention.

FIG. 17 is a block diagram of a second system in accordance with an embodiment of the invention.

FIG. 18 is a block diagram of a third system in accordance with an embodiment of the invention.

FIG. 19 is a block diagram of a SoC in accordance with an embodiment of the invention.

FIG. 20 is a block diagram of a single core processor and a multicore processor with integrated memory controller and graphics according to embodiments of the invention.

FIG. 21 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Detailed below are several embodiments of “expand” and “compress” instructions and embodiments of systems, architectures, instruction formats etc. that may be used to execute such instructions. Expand and compress that are beneficial in several different areas including converting AoS and SoA arrangements. For example, going from XYZW XYZW XYZW . . . XYZW patterns to XXXXXXXX YYYYYYYY ZZZZZZZZZZ WWWWWWWW kind of patterns. Another such area is matrix transposition. A vector with a length of 16 could be viewed as a 4×4 array of elements. With an expand instruction, a row of four consecutive elements M[0], M[1], M[2], and M[3] could be fetched and expanded (with merging to keep building up the array) into one of the 4×4 array rows (for instance, vector elements 1, 3, 7, and 11).

Additionally, general purpose code that stores memory into consecutive locations based on a dynamic condition would benefit from compress and expand instructions. For example, in some cases it is advantageous to compress rare elements that have an uncommon condition into a temporal memory space. Storing them packed together increases the density of computation. One way to do so is through the use of compress which is detailed below. After processing temporal memory space (or FIFO), expand may be used to restore those rare elements back to their original position. Expand is also used for re-expanding data that was packed into a queue.

Expand

Starting with expand, the execution of expand causes a processor to write consecutive data elements from a source operand (a memory or register operand) to (sparse) data element positions in a destination operand (typically a register operand) based on the active elements determined by the writemask operand. Additionally, the data elements of the source operand may be upconverted depending on their size and what size data elements are in the destination register. For example, if the source operand is a memory operand and its data elements are 16-bit in size and the data elements of the destination register are 32-bit, then they data elements of the memory operand to be stored in the destination are upconverted to be 32-bit. Examples of upconversion and how they are encoded into an instruction format will be detailed later.

A format of this instruction is “VEXPANDPS zmm1{k1}zmm2/U(mem),” where zmm1 and zmm2 are a destination and source vector register operand respectively (such as a 128-, 256-, 512-bit register, etc.), k1 is a writemask operand (such as a 16-bit register), and U(mem) is a source memory location operand. Whatever is retrieved from memory is a collection consecutive bits starting from the memory address and may one of several sizes (128-, 256-, 512-bit, etc.) depending on the size of the destination register—the size is generally the same size as the destination register. In some embodiments, the writemask is also of a different size (8 bits, 32 bits, etc.). Additionally, in some embodiments, not all bits of the writemask are utilized by the instruction (for example, only the lower eight least significant bits are used). Of course, VEXPANDPS is the instruction's opcode. Typically, each operand is explicitly defined in the instruction. The size of the data elements may be defined in the “prefix” of the instruction such as through the use of an indication of data granularity bit like “W” described later. In most embodiments, W will indicate that each data elements are either 32 or 64 bits. If the data elements are 32 bits in size, and the sources are 512 bits in size, then there are sixteen (16) data elements per source.

This instruction is normally writemasked so that only those elements with the corresponding bit set in a writemask register, k1 in the example above, are modified in the destination register. Elements in the destination register with the corresponding bit clear in the writemask register retain their previous values. However, when using no writemask (or a writemask set to all ones), this instruction may be used for higher performance vector loads where there is a high confidence that the memory reference will produce a cache-line split.

An example of an expand instruction's execution is illustrated in FIG. 1. In this example, the source is memory is addressed at an address found in the RAX register. Of course, the memory address may be stored in other registers or found as an immediate in the instruction. The writemask in this example is shown as 0x4 DB1. For each bit position of the writemask with a “1” value, a data element from the memory source is stored in the destination register at the corresponding position. For example, the first position of the writemask (e.g., k2[0]) is “1” which indicates that the corresponding destination data element position (e.g., the first data element of the destination register) will have a data element from the source memory stored there. In this case, it would be the data element associated with the RAX address. The next three bits of the mask are “0” which indicates that the corresponding data elements of the destination register are left alone (shown as being “Y” in the figure). The next “1” value in the writemask is in the fifth bit position (e.g., k2[4]). This indicates that the data element that is subsequent (consecutive) to the data element associated with the RAX register is to be stored in the fifth data element slot of the destination register. The remaining writemask bit positions are used to determine which additional data elements of the memory source are to be stored in the destination register (in this instance, eight total data elements are stored, but there could be fewer or more depending on the writemask). Additionally, the data elements from the memory source may be upconverted to fit the data element size of the destination such as going from a 16-bit floating point value to a 32-bit value prior to storage in the destination. Examples of upconversion and how to encode them into an instruction format have been detailed above. Additionally, in some embodiments, the consecutive data elements of the memory operand are stored in a register prior to the expansion.

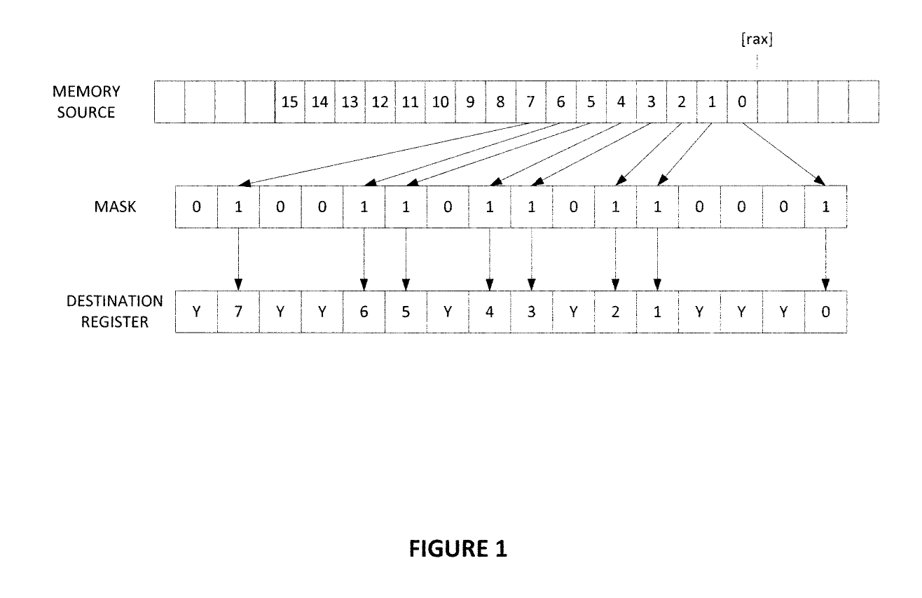

FIG. 2 illustrates an example of an expand instruction's execution with a register operand as the source. Like the previous figure, the writemask in this example is 0x4 DB1. For each bit position of the writemask with a “1” value, a data element from the register source is stored in the destination register at the corresponding position. For example, the first position of the writemask (e.g., k2[0]) is “1” which indicates that the corresponding destination data element position (e.g., the first data element of the destination register) will have a data element from the source register stored there. In this case, it would be the first data element of the source register. The next three bits of the mask are “0” which indicates that the corresponding data elements of the destination register are left alone (shown as being “Y” in the figure). The next “1” value in the writemask is in the fifth bit position (e.g., k2[4]). This indicates that the data element that is subsequent (consecutive) to the first stored data of the source register is to be stored in the fifth data element slot of the destination register. The remaining writemask bit positions are used to determine which additional data elements of the register source are to be stored in the destination register (in this instance, eight total data elements are stored, but there could be fewer or more depending on the writemask).

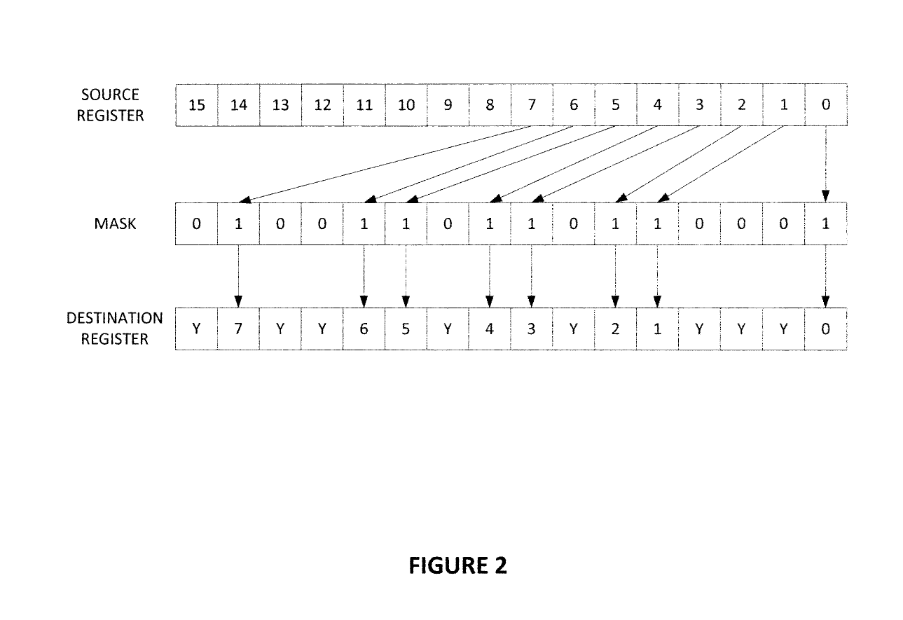

FIG. 3 illustrates an example of pseudo code for executing an expand instruction.

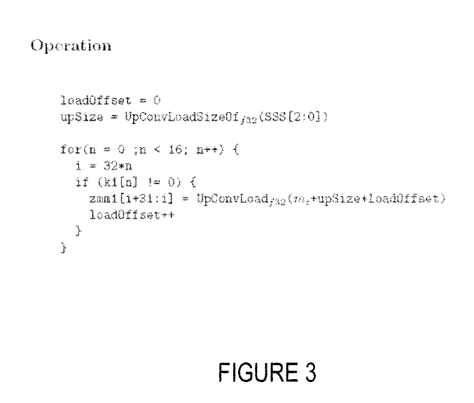

FIG. 4 illustrates an embodiment of the use of an expand instruction in a processor. An expand instruction with a destination operand, a source operand (memory or register), writemask, and an offset (if included) is fetched at 401. In some embodiments, the destination operand is a 512-bit vector register (such as ZMM1) and the writemask is a 16-bit register (such as k1). If there is a memory source operand it may be a register storing an address (or a portion thereof) or an immediate representing an address or portion thereof. Typically, the destination and source operands are of the same size. In some embodiments, they are all 512 bits in size. However, in other embodiments they may all be different sizes such as 128 or 256 bits.

The expand instruction is decoded at 403. Depending on the instruction's format, a variety of data may be interpreted at this stage such as if there is to be an upconversion (or other data transformation), which registers to write to and retrieve, what the memory address is from the source, etc.

The source operand values at retrieved/read at 405. In most embodiments, the data elements associated with the memory source location address and consecutive (subsequent) addresses (and their data elements) are read at this time (for example, an entire cache line is read). In embodiments where the source is a register it is read at this time.

If there is any data element transformation to be performed (such as an upconversion) it may be performed at 407. For example, a 16-bit data element from memory may be upconverted into a 32-bit data element.

The expand instruction (or operations comprising such an instruction such as microoperations) is executed by execution resources at 409. This execution causes the determination of which values from the source operand are to be stored as sparse data elements in the destination based on the “active” elements (bit positions) of the writemask. An example of such a determination was illustrated in FIGS. 1 and 2.

The appropriate data elements of the source operand are stored into the destination register at locations that correspond to the “active” elements of the writemask at 411. Again, examples of this are shown in FIGS. 1 and 2. While 409 and 411 have been illustrated separately, in some embodiments they are performed together as a part of the execution of the instruction.

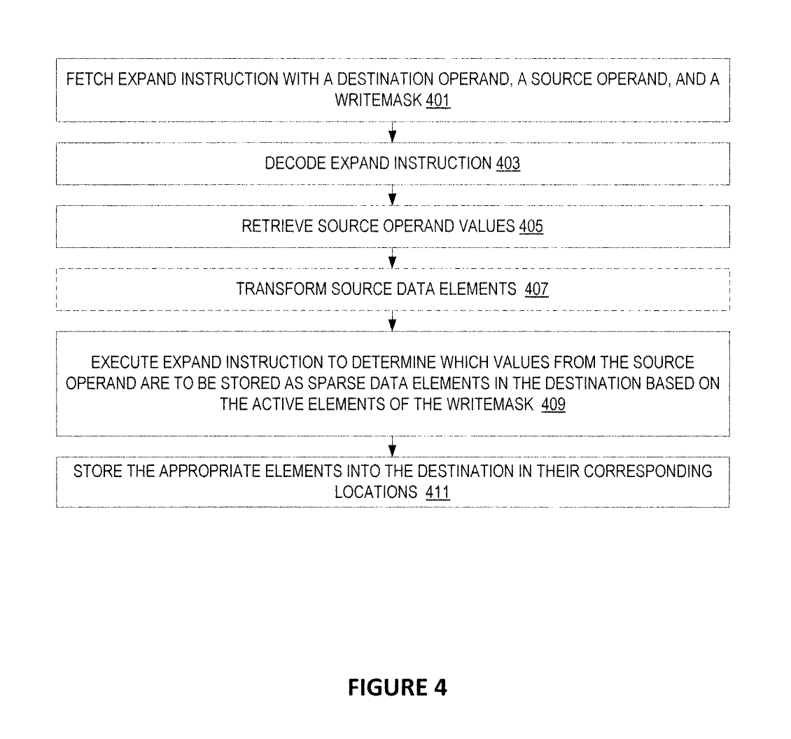

FIG. 5 illustrates an embodiment of a method for processing a expand instruction. In this embodiment it is assumed that some, if not all, of the operations 401-407 have been performed previously, however, they are not shown in order to not obscure the details presented below. For example, the fetching and decoding are not shown, nor is the operand (sources and writemask) retrieval shown.

At 501, a determination of if the writemask at the first bit position indicates that a corresponding source location should be stored into a corresponding data element location of the destination register is made. For example, does the writemask at the first position have a value such as a “1” that indicates that the first data element position of the destination register should be overwritten with a value from the source (in this case the first data element of the consecutive data elements that are accessed through the source operand)?

When the writemask at the first bit position does not indicate that there should be a change in the destination register, then the next bit position in the writemask will be evaluated and no change is made. When the writemask at the first bit position indicates that there should be a change in that first data element position of the destination, then the first source data element (e.g., the least significant data element of the memory location or source register) is stored into the first data element position at 507. Depending on the implementation, the memory data element is converted to the data element size of the destination at 505. This could have also occurred prior to the evaluation of 501. The subsequent (consecutive) data element from the source that may be written into the destination register is readied at 511.

A determination of if the evaluated writemask position was the last of the writemask or if all of the data element positions of the destination have been filled is made at 513. If true, then the operation is over

If not true, then the next bit position in the writemask at 515 is to be evaluated. This evaluation occurs at 503 and is similar to the determination of 501 but it is not for the first bit position of the writemask. If the determination is a yes, then the data element is stored, etc. (507, 509, and 511) and if the determination is a no, then the data element of the destination is left alone at 505.

Additionally, while this figure and above description considers the respective first positions to be the least significant positions, in some embodiments the first positions are the most significant positions.

Compress

The execution of a compress instruction causes a processor to store (pack) data elements from a source operand (typically a register operand) into consecutive elements in a destination operand (a memory or register operand) based on the active elements determined by the writemask operand. Additionally, the data elements of the source operand may be downconverted depending on their size and what size data elements are if the source is memory. For example, if the data elements of the memory operand are 16-bit in size and the data elements of the source register are 32-bit, then they data elements of the register to be stored in the memory are downconverted to be 16-bit. Examples of downconversion and how they are encoded into an instruction format will be detailed later. The execution of compress could also be viewed as creating a byte/word/doubleword stream logically mapped starting at an element-aligned address. The length of the stream depends on the writemask as elements disabled by the mask are not added to the stream. Compress is typically used for compressing sparse data into a queue. Additionally, using no writemask (or a writemask set to all ones), it may be used for higher performance vector stores where there is a high confidence that the memory reference will produce a cache-line split.

A format of this instruction is “VCOMPRESSPS zmm2/mem{k1}, D(zmm1),” where zmm1 and zmm2 are a source and destination vector register operand (such as a 128-, 246-, 512-bit register) respectively, k1 is a writemask operand (such as a 16-bit register), and mem is a memory location. There also may be an offset for a memory operand included in the instruction. Whatever is stored to memory is a collection consecutive bits starting from the memory address and may one of several sizes (128-, 256-, 512-bit, etc.). In some embodiments, the writemask is also of a different size (8 bits, 32 bits, etc.). Additionally, in some embodiments, not all bits of the writemask are utilized by the instruction (for example, only the lower eight least significant bits are used). Of course, VCOMPRESSPS is the instruction's opcode. Typically, each operand is explicitly defined in the instruction. The size of the data elements may be defined in the “prefix” of the instruction such as through the use of an indication of data granularity bit like “W” described herein. In most embodiments, W will indicate that each data elements are either 32 or 64 bits. If the data elements are 32 bits in size, and the sources are 512 bits in size, then there are sixteen (16) data elements per source.

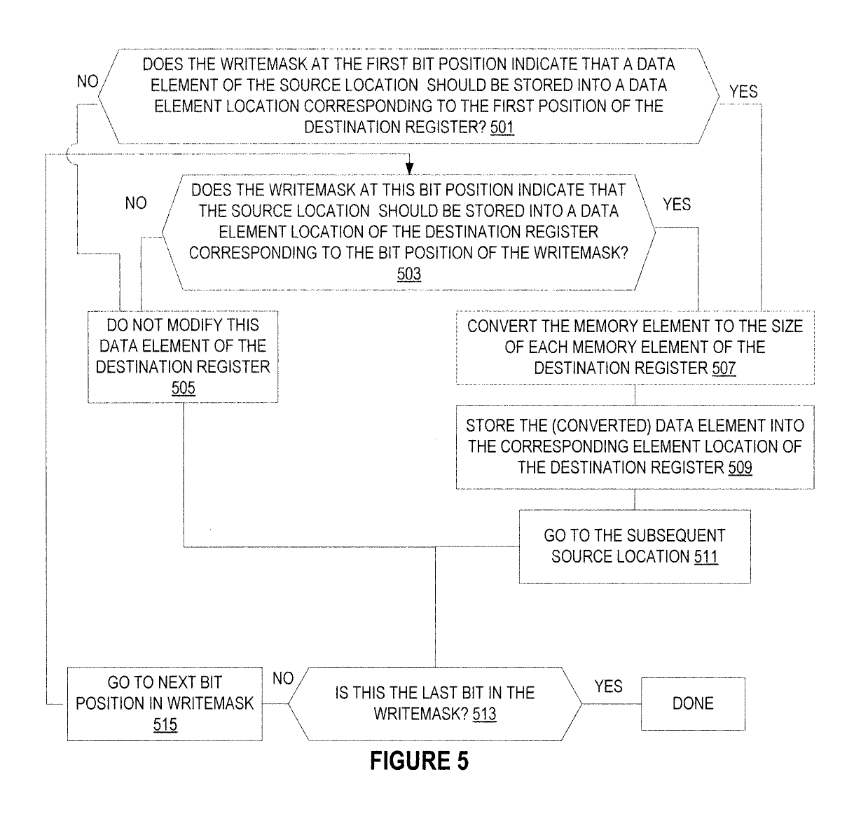

An example of a compress instruction's execution in a processor is illustrated in FIG. 6. In this example the destination memory is addressed at an address associated with the one found in the RAX register. Of course, the memory address may be stored in other registers or found as an immediate in the instruction. The writemask in this example is 0x4 DB1. For each instance that the writemask has a “1” value, a data element from the source (such as a ZMM register) is stored (packed) consecutively into the memory. For example, the first position of the writemask (e.g., k2[0]) is “1” which indicates that the corresponding source data element position (e.g., the first data element of the source register) should be written into the memory. In this case, it would be stored as the data element associated with the RAX address. The next three bits of the mask are “0” which indicates that the corresponding data elements of the source register are not stored in the memory (shown as being “Y” in the figure). The next “1” value in the writemask is in the fifth bit position (e.g., k2[4]). This indicates that the data element position that is subsequent (consecutive) to the data element associated with the RAX register is to have the fifth data element slot of the source register stored there. The remaining writemask bit positions are used to determine which additional data elements of the source register are to be stored in the memory (in this instance, eight total data elements are stored, but there could be fewer or more depending on the writemask). Additionally, the data elements from the register source may be downconverted to fit the data element size of the memory such as going from a 32-bit floating point value to a 16-bit value prior to storage.

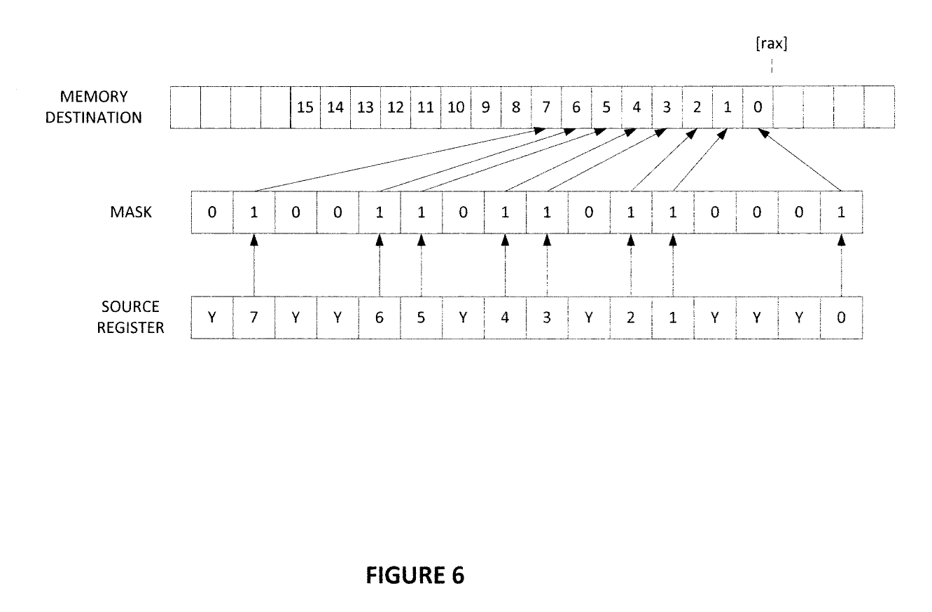

FIG. 7 illustrates another example of a compress instruction's execution in a processor. In this example the destination is a register. The writemask in this example is again 0x4 DB1. For each instance that the writemask has a “1” value, a data element from the source (such as a ZMM register) is stored (packed) consecutively into the destination register. For example, the first position of the writemask (e.g., k2[0]) is “1” which indicates that the corresponding source data element position (e.g., the first data element of the source register) should be written into the destination register. In this case, it would be stored as the first data element of the destination register. The next three bits of the mask are “0” which indicates that the corresponding data elements of the source register are not stored in the destination register (shown as being “Y” in the figure). The next “1” value in the writemask is in the fifth bit position (e.g., k2[4]). This indicates that the data element position that is subsequent (consecutive) to the first data element is to have the fifth data element slot of the source register stored there. The remaining writemask bit positions are used to determine which additional data elements of the source register are to be stored in the destination register (in this instance, eight total data elements are stored, but there could be fewer or more depending on the writemask).

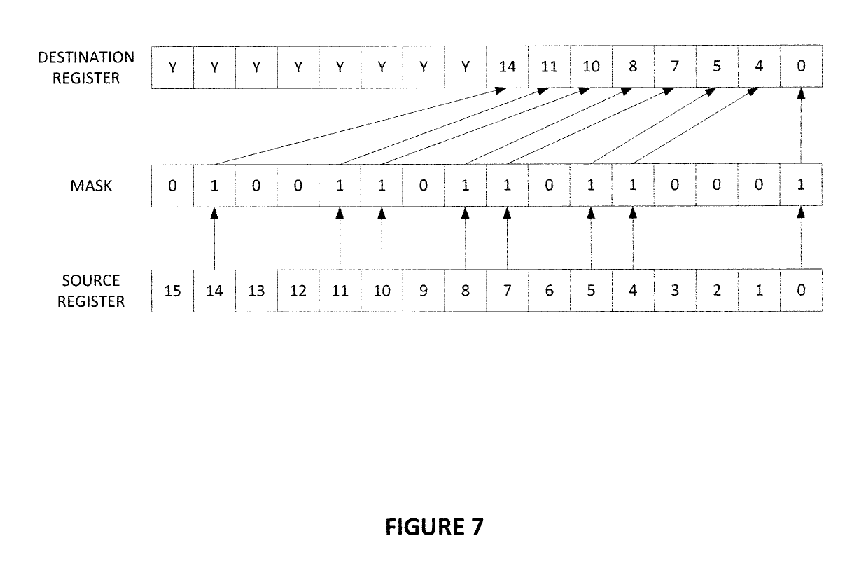

FIG. 8 illustrates an example of pseudo code for executing an expand instruction.

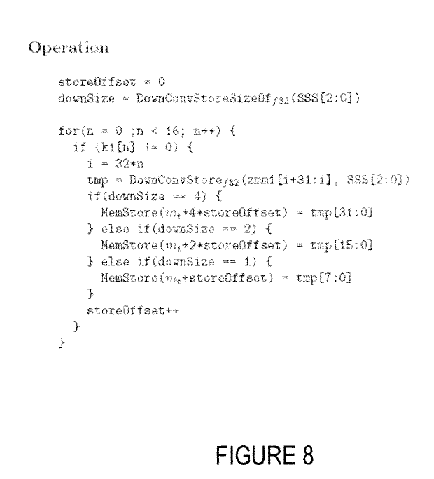

FIG. 9 illustrates an embodiment of the use of a compress instruction in a processor. A compress instruction with a destination operand, a source operand, and a writemask is fetched at 901. In some embodiments, the source operand is a 512-bit vector register (such as ZMM1) and the writemask is a 16-bit register (such as k1). The destination may be memory location stored in a register or as an immediate, or a register operand. Additionally, the compress instruction may include an offset for a memory address.

The compress instruction is decoded at 903. Depending on the instruction's format, a variety of data may be interpreted at this stage such as if there is to be a downconversion, which registers to and retrieve, what the memory address is from the destination operand (and offset if any), etc.

The source operand values are retrieved/read at 905. For example, at least the first data element of the source register is read.

If there is any data element transformation to be performed (such as a downconversion) it may be performed at 907. For example, a 32-bit data element from the register may be downconverted into a 16-bit data element.

The compress instruction (or operations comprising such an instruction such as microoperations) is executed by execution resources at 909. This execution causes the determination of which values from the source operand are to be loaded as packed data elements in the destination based on the “active” elements (bit positions) of the writemask. An example of such an analysis was illustrated in FIG. 6.

The appropriate data elements of the source operand that correspond to the “active” elements of the writemask are stored into the destination at 911. Again, an example of this is shown in FIGS. 6 and 7. While 909 and 911 have been illustrated separately, in some embodiments they are performed together as a part of the execution of the instruction.

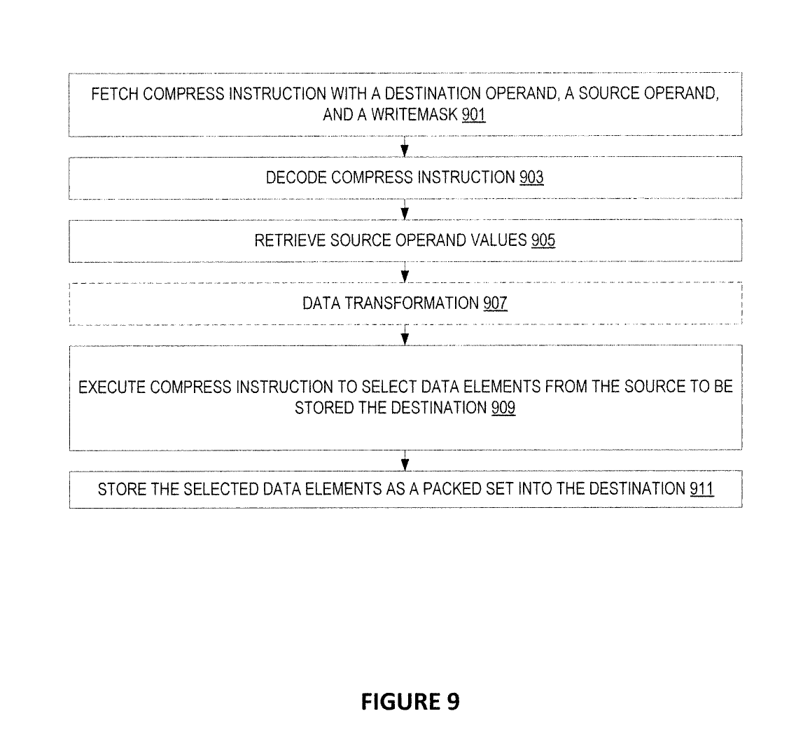

FIG. 10 illustrates an example of an embodiment of a method for processing a compress instruction. In this embodiment it is assumed that some, if not all, of the operations 901-907 have been performed previously, however, they are not shown in order to not obscure the details presented below. For example, the fetching and decoding are not shown, nor is the operand (sources and writemask) retrieval shown.

At 1001, a determination of if the writemask at the first bit position indicates that a corresponding source data element should be stored into a destination location initially indicated by the destination operand (least significant location). For example, does the mask at the first position have a value such as a “1” that indicates that the first data element position of the source register should be written into the memory?

When the writemask at the first bit position does not indicate that there should be a change in the destination (the first data element should remain unchanged by the first data element of the source register), then the next bit position in the writemask will be evaluated (if there is one) and no change is made. When the writemask at the first bit position indicates that there should be a change in that first data element position of the destination, then the source data element is stored into the first data element position of the destination at 1007. Depending on the implementation, there source data element is converted to the data element size of the destination at 1005. This could have also occurred prior to the evaluation of 1001. The subsequent (consecutive) destination location that may be written into is readied at 1009.

A determination of if the evaluated writemask position was the last of the writemask or if all of the data element positions of the destination have been filled is made at 1011. If true, then the operation is over. If not true, then the next bit position in the writemask at 1013 is to be evaluated. This evaluation occurs at 1003 and is similar to the determination of 1001 but for it is not the first bit position of the write mask. If the determination is a yes, then the data element is stored, etc. (1005, 1007, and 1009).

Additionally, while this figure and above description considers the respective first positions to be the least significant positions, in some embodiments the first positions are the most significant positions.

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

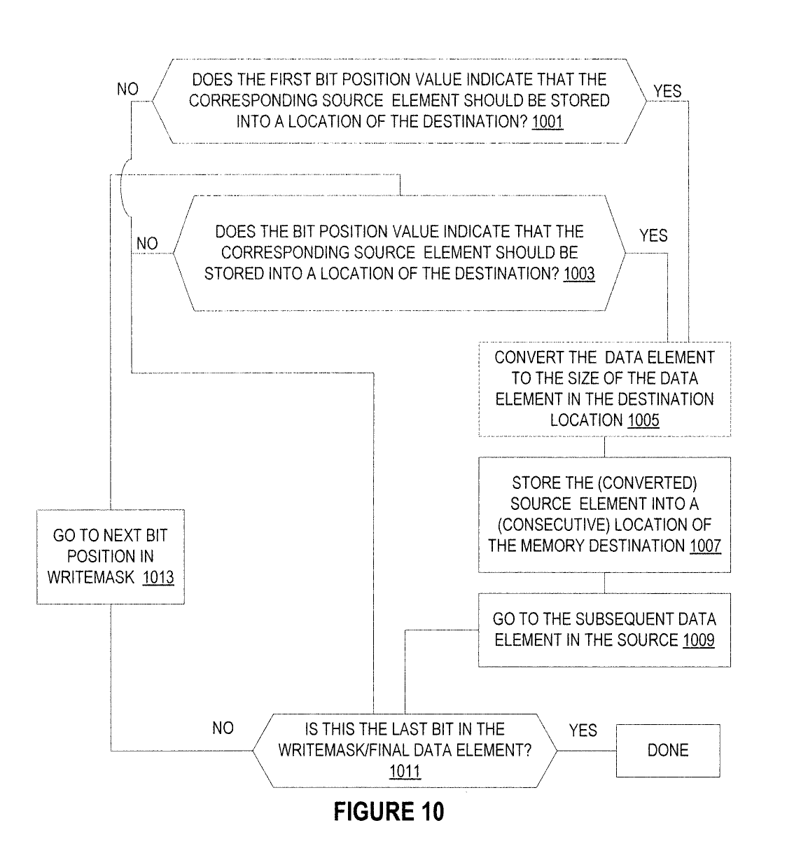

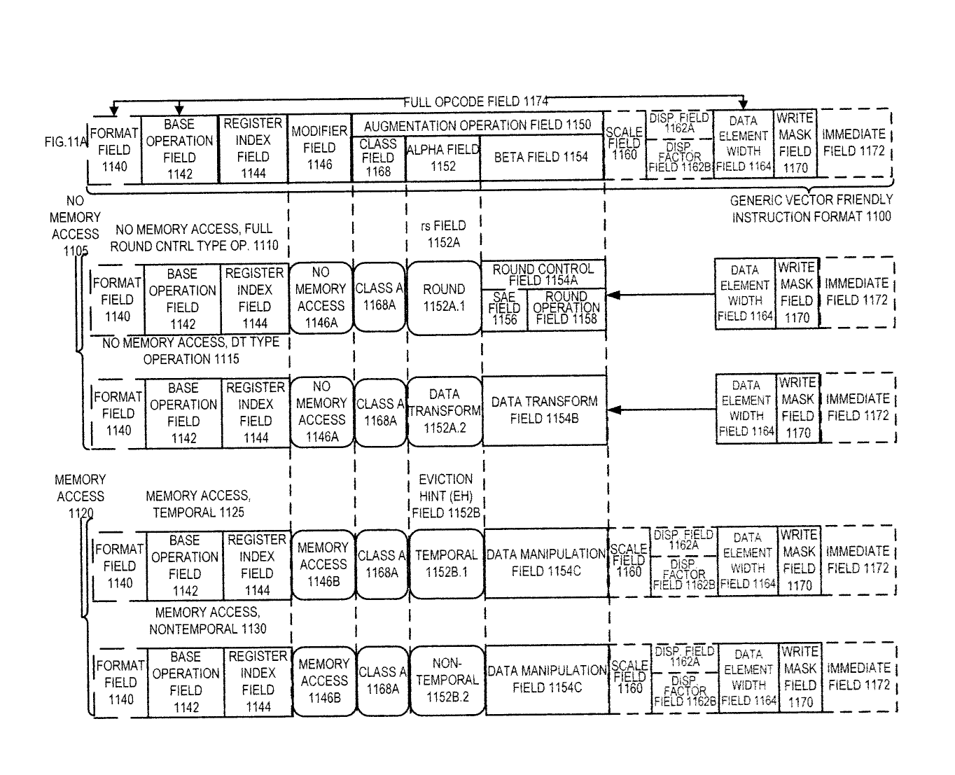

Exemplary Generic Vector Friendly Instruction Format—FIG. 11A-B

FIGS. 11A-B are block diagrams illustrating a generic vector friendly instruction format and instruction templates thereof according to embodiments of the invention. FIG. 11A is a block diagram illustrating a generic vector friendly instruction format and class A instruction templates thereof according to embodiments of the invention; while FIG. 11B is a block diagram illustrating the generic vector friendly instruction format and class B instruction templates thereof according to embodiments of the invention. Specifically, a generic vector friendly instruction format 1100 for which are defined class A and class B instruction templates, both of which include no memory access 1105 instruction templates and memory access 1120 instruction templates. The term generic in the context of the vector friendly instruction format refers to the instruction format not being tied to any specific instruction set. While embodiments will be described in which instructions in the vector friendly instruction format operate on vectors that are sourced from either registers (no memory access 1105 instruction templates) or registers/memory (memory access 1120 instruction templates), alternative embodiments of the invention may support only one of these. Also, while embodiments of the invention will be described in which there are load and store instructions in the vector instruction format, alternative embodiments instead or additionally have instructions in a different instruction format that move vectors into and out of registers (e.g., from memory into registers, from registers into memory, between registers). Further, while embodiments of the invention will be described that support two classes of instruction templates, alternative embodiments may support only one of these or more than two.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 1156 byte vector operands) with more, less, or different data element widths (e.g., 128 bit (16 byte) data element widths).

The class A instruction templates in FIG. 11A include: 1) within the no memory access 1105 instruction templates there is shown a no memory access, full round control type operation 1110 instruction template and a no memory access, data transform type operation 1115 instruction template; and 2) within the memory access 1120 instruction templates there is shown a memory access, temporal 1125 instruction template and a memory access, non-temporal 1130 instruction template. The class B instruction templates in FIG. 11B include: 1) within the no memory access 1105 instruction templates there is shown a no memory access, write mask control, partial round control type operation 1112 instruction template and a no memory access, write mask control, vsize type operation 1117 instruction template; and 2) within the memory access 1120 instruction templates there is shown a memory access, write mask control 1127 instruction template.

Format

The generic vector friendly instruction format 1100 includes the following fields listed below in the order illustrated in FIGS. 11A-B.

Format field 1140—a specific value (an instruction format identifier value) in this field uniquely identifies the vector friendly instruction format, and thus occurrences of instructions in the vector friendly instruction format in instruction streams. Thus, the content of the format field 1140 distinguish occurrences of instructions in the first instruction format from occurrences of instructions in other instruction formats, thereby allowing for the introduction of the vector friendly instruction format into an instruction set that has other instruction formats. As such, this field is optional in the sense that it is not needed for an instruction set that has only the generic vector friendly instruction format.

Base operation field 1142—its content distinguishes different base operations. As described later herein, the base operation field 1142 may include and/or be part of an opcode field.

Register index field 1144—its content, directly or through address generation, specifies the locations of the source and destination operands, be they in registers or in memory. These include a sufficient number of bits to select N registers from a PxQ (e.g. 32×1312) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination). While in one embodiment P=32, alternative embodiments may support more or less registers (e.g., 16). While in one embodiment Q=1312 bits, alternative embodiments may support more or less bits (e.g., 128, 1024).

Modifier field 1146—its content distinguishes occurrences of instructions in the generic vector instruction format that specify memory access from those that do not; that is, between no memory access 1105 instruction templates and memory access 1120 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 1150—its content distinguishes which one of a variety of different operations to be performed in addition to the base operation. This field is context specific. In one embodiment of the invention, this field is divided into a class field 1168, an alpha field 1152, and a beta field 1154. The augmentation operation field allows common groups of operations to be performed in a single instruction rather than 2, 3 or 4 instructions. Below are some examples of instructions (the nomenclature of which are described in more detail later herein) that use the augmentation field 1150 to reduce the number of required instructions.

| | Instructions Sequences according to |
|---|---|
| Prior Instruction Sequences | on Embodiment of the Invention |
| vaddps ymm0, ymm1, | vaddps zmm0, zmm1, zmm2 |
| ymm2 | |
| vpshufd ymm2, ymm2, 0x55 | vaddps zmm0, zmm1, zmm2 {bbbb} |
| vaddps ymm0, ymm1, ymm2 | |
| vpmovsxbd ymm2, [rax] | vaddps zmm0, zmm1, [rax]{sint8} |
| vcvtdq2ps ymm2, ymm2 | |
| vaddps ymm0, ymm1, ymm2 | |
| vpmovsxbd ymm3, [rax] | vaddps zmm1{k5}, zmm2, |
| vcvtdq2ps ymm3, ymm3 | [rax]{sint8} |
| vaddps ymm4, ymm2, ymm3 | |
| vblendvps ymm1, ymm5, | |
| ymm1, ymm4 | |
| vmaskmovps ymm1, ymm7, [rbx] | vmovaps zmm1 {k7}, [rbx] |
| vbroadcastss ymm0, [rax] | vaddps zmm2{k7}{z}, zmm1, |
| vaddps ymm2, ymm0, ymm1 | [rax]{1toN} |
| vblendvps ymm2, ymm2, | |
| ymm1, ymm7 | |

Where [rax] is the base pointer to be used for address generation, and where { } indicates a conversion operation specified by the data manipulation filed (described in more detail later here).

Scale field 1160—its content allows for the scaling of the index field's content for memory address generation (e.g., for address generation that uses 2^{scale}*index+base).

Displacement Field 1162A—its content is used as part of memory address generation (e.g., for address generation that uses 2^{scale}*index+base+displacement).

Displacement Factor Field 1162B (note that the juxtaposition of displacement field 1162A directly over displacement factor field 1162B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 1174 (described later herein) and the data manipulation field 1154C as described later herein. The displacement field 1162A and the displacement factor field 1162B are optional in the sense that they are not used for the no memory access 1105 instruction templates and/or different embodiments may implement only one or none of the two.

Data element width field 1164—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 1170—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 1170 allows for partial vector operations, including loads, stores, arithmetic, logical, etc. Also, this masking can be used for fault suppression (i.e., by masking the destination's data element positions to prevent receipt of the result of any operation that may/will cause a fault—e.g., assume that a vector in memory crosses a page boundary and that the first page but not the second page would cause a page fault, the page fault can be ignored if all data element of the vector that lie on the first page are masked by the write mask). Further, write masks allow for “vectorizing loops” that contain certain types of conditional statements. While embodiments of the invention are described in which the write mask field's 1170 content selects one of a number of write mask registers that contains the write mask to be used (and thus the write mask field's 1170 content indirectly identifies that masking to be performed), alternative embodiments instead or additional allow the mask write field's 1170 content to directly specify the masking to be performed. Further, zeroing allows for performance improvements when: 1) register renaming is used on instructions whose destination operand is not also a source (also call non-ternary instructions) because during the register renaming pipeline stage the destination is no longer an implicit source (no data elements from the current destination register need be copied to the renamed destination register or somehow carried along with the operation because any data element that is not the result of operation (any masked data element) will be zeroed); and 2) during the write back stage because zeros are being written.

Immediate field 1172—its content allows for the specification of an immediate. This field is optional in the sense that is it not present in an implementation of the generic vector friendly format that does not support immediate and it is not present in instructions that do not use an immediate.

Instruction Template Class Selection

Class field 1168—its content distinguishes between different classes of instructions. With reference to FIGS. 2A-B, the contents of this field select between class A and class B instructions. In FIGS. 11A-B, rounded corner squares are used to indicate a specific value is present in a field (e.g., class A 1168A and class B 1168B for the class field 1168 respectively in FIGS. 11A-B).

No-Memory Access Instruction Templates of Class A

In the case of the non-memory access 1105 instruction templates of class A, the alpha field 1152 is interpreted as an RS field 1152A, whose content distinguishes which one of the different augmentation operation types are to be performed (e.g., round 1152A.1 and data transform 1152A.2 are respectively specified for the no memory access, round type operation 1110 and the no memory access, data transform type operation 1115 instruction templates), while the beta field 1154 distinguishes which of the operations of the specified type is to be performed. In FIG. 11, rounded corner blocks are used to indicate a specific value is present (e.g., no memory access 1146A in the modifier field 1146; round 1152A.1 and data transform 1152A.2 for alpha field 1152/rs field 1152A). In the no memory access 1105 instruction templates, the scale field 1160, the displacement field 1162A, and the displacement scale filed 1162B are not present.

No-Memory Access Instruction Templates—Full Round Control Type Operation

In the no memory access full round control type operation 1110 instruction template, the beta field 1154 is interpreted as a round control field 1154A, whose content(s) provide static rounding. While in the described embodiments of the invention the round control field 1154A includes a suppress all floating point exceptions (SAE) field 1156 and a round operation control field 1158, alternative embodiments may support may encode both these concepts into the same field or only have one or the other of these concepts/fields (e.g., may have only the round operation control field 1158).

SAE field 1156—its content distinguishes whether or not to disable the exception event reporting; when the SAE field's 1156 content indicates suppression is enabled, a given instruction does not report any kind of floating-point exception flag and does not raise any floating point exception handler.

Round operation control field 1158—its content distinguishes which one of a group of rounding operations to perform (e.g., Round-up, Round-down, Round-towards-zero and Round-to-nearest). Thus, the round operation control field 1158 allows for the changing of the rounding mode on a per instruction basis, and thus is particularly useful when this is required. In one embodiment of the invention where a processor includes a control register for specifying rounding modes, the round operation control field's 1150 content overrides that register value (Being able to choose the rounding mode without having to perform a save-modify-restore on such a control register is advantageous).

No Memory Access Instruction Templates—Data Transform Type Operation

In the no memory access data transform type operation 1115 instruction template, the beta field 1154 is interpreted as a data transform field 1154B, whose content distinguishes which one of a number of data transforms is to be performed (e.g., no data transform, swizzle, broadcast).

Memory Access Instruction Templates of Class A

In the case of a memory access 1120 instruction template of class A, the alpha field 1152 is interpreted as an eviction hint field 1152B, whose content distinguishes which one of the eviction hints is to be used (in FIG. 11A, temporal 1152B.1 and non-temporal 1152B.2 are respectively specified for the memory access, temporal 1125 instruction template and the memory access, non-temporal 1130 instruction template), while the beta field 1154 is interpreted as a data manipulation field 1154C, whose content distinguishes which one of a number of data manipulation operations (also known as primitives) is to be performed (e.g., no manipulation; broadcast; up conversion of a source; and down conversion of a destination). The memory access 1120 instruction templates include the scale field 1160, and optionally the displacement field 1162A or the displacement scale field 1162B.

Vector Memory Instructions perform vector loads from and vector stores to memory, with conversion support. As with regular vector instructions, vector memory instructions transfer data from/to memory in a data element-wise fashion, with the elements that are actually transferred dictated by the contents of the vector mask that is selected as the write mask. In FIG. 11A, rounded corner squares are used to indicate a specific value is present in a field (e.g., memory access 1146B for the modifier field 1146; temporal 1152B.1 and non-temporal 1152B.2 for the alpha field 1152/eviction hint field 1152B).

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 1152 is interpreted as a write mask control (Z) field 1152C, whose content distinguishes whether the write masking controlled by the write mask field 1170 should be a merging or a zeroing.

No-Memory Access Instruction Templates of Class B

In the case of the non-memory access 1105 instruction templates of class B, part of the beta field 1154 is interpreted as an RL field 1157A, whose content distinguishes which one of the different augmentation operation types are to be performed (e.g., round 1157A.1 and vector length (VSIZE) 1157A.2 are respectively specified for the no memory access, write mask control, partial round control type operation 1112 instruction template and the no memory access, write mask control, VSIZE type operation 1117 instruction template), while the rest of the beta field 1154 distinguishes which of the operations of the specified type is to be performed. In FIG. 11, rounded corner blocks are used to indicate a specific value is present (e.g., no memory access 1146A in the modifier field 1146; round 1157A.1 and VSIZE 1157A.2 for the RL field 1157A). In the no memory access 1105 instruction templates, the scale field 1160, the displacement field 1162A, and the displacement scale filed 1162B are not present.

No-Memory Access Instruction Templates—Write Mask Control, Partial Round Control Type Operation

In the no memory access, write mask control, partial round control type operation 1110 instruction template, the rest of the beta field 1154 is interpreted as a round operation field 1159A and exception event reporting is disabled (a given instruction does not report any kind of floating-point exception flag and does not raise any floating point exception handler).

Round operation control field 1159A—just as round operation control field 1158, its content distinguishes which one of a group of rounding operations to perform (e.g., Round-up, Round-down, Round-towards-zero and Round-to-nearest). Thus, the round operation control field 1159A allows for the changing of the rounding mode on a per instruction basis, and thus is particularly useful when this is required. In one embodiment of the invention where a processor includes a control register for specifying rounding modes, the round operation control field's 1150 content overrides that register value (Being able to choose the rounding mode without having to perform a save-modify-restore on such a control register is advantageous).

No Memory Access Instruction Templates—Write Mask Control, VSIZE Type Operation

In the no memory access, write mask control, VSIZE type operation 1117 instruction template, the rest of the beta field 1154 is interpreted as a vector length field 1159B, whose content distinguishes which one of a number of data vector length is to be performed on (e.g., 128, 1156, or 1312 byte).

Memory Access Instruction Templates of Class B

In the case of a memory access 1120 instruction template of class A, part of the beta field 1154 is interpreted as a broadcast field 1157B, whose content distinguishes whether or not the broadcast type data manipulation operation is to be performed, while the rest of the beta field 1154 is interpreted the vector length field 1159B. The memory access 1120 instruction templates include the scale field 1160, and optionally the displacement field 1162A or the displacement scale field 1162B.

Additional Comments Regarding Fields

With regard to the generic vector friendly instruction format 1100, a full opcode field 1174 is shown including the format field 1140, the base operation field 1142, and the data element width field 1164. While one embodiment is shown where the full opcode field 1174 includes all of these fields, the full opcode field 1174 includes less than all of these fields in embodiments that do not support all of them. The full opcode field 1174 provides the operation code.

The augmentation operation field 1150, the data element width field 1164, and the write mask field 1170 allow these features to be specified on a per instruction basis in the generic vector friendly instruction format.

The combination of write mask field and data element width field create typed instructions in that they allow the mask to be applied based on different data element widths.

The instruction format requires a relatively small number of bits because it reuses different fields for different purposes based on the contents of other fields. For instance, one perspective is that the modifier field's content choses between the no memory access 1105 instructions templates on FIGS. 11A-B and the memory access 11250 instruction templates on FIGS. 11A-B; while the class field 1168's content choses within those non-memory access 1105 instruction templates between instruction templates 1110/1115 of FIG. 11A and 1112/1117 of FIG. 11B; and while the class field 1168's content choses within those memory access 1120 instruction templates between instruction templates 1125/1130 of FIGS. 11A and 1127 of FIG. 11B. From another perspective, the class field 1168's content choses between the class A and class B instruction templates respectively of FIGS. 11A and B; while the modifier field's content choses within those class A instruction templates between instruction templates 1105 and 1120 of FIG. 11A; and while the modifier field's content choses within those class B instruction templates between instruction templates 1105 and 1120 of FIG. 11B. In the case of the class field's content indicating a class A instruction template, the content of the modifier field 1146 choses the interpretation of the alpha field 1152 (between the rs field 1152A and the EH field 1152B. In a related manner, the contents of the modifier field 1146 and the class field 1168 chose whether the alpha field is interpreted as the rs field 1152A, the EH field 1152B, or the write mask control (Z) field 1152C. In the case of the class and modifier fields indicating a class A no memory access operation, the interpretation of the augmentation field's beta field changes based on the rs field's content; while in the case of the class and modifier fields indicating a class B no memory access operation, the interpretation of the beta field depends on the contents of the RL field. In the case of the class and modifier fields indicating a class A memory access operation, the interpretation of the augmentation field's beta field changes based on the base operation field's content; while in the case of the class and modifier fields indicating a class B memory access operation, the interpretation of the augmentation field's beta field's broadcast field 1157B changes based on the base operation field's contents. Thus, the combination of the base operation field, modifier field and the augmentation operation field allow for an even wider variety of augmentation operations to be specified.

The various instruction templates found within class A and class B are beneficial in different situations. Class A is useful when zeroing-writemasking or smaller vector lengths are desired for performance reasons. For example, zeroing allows avoiding fake dependences when renaming is used since we no longer need to artificially merge with the destination; as another example, vector length control eases store-load forwarding issues when emulating shorter vector sizes with the vector mask. Class B is useful when it is desirable to: 1) allow floating point exceptions (i.e., when the contents of the SAE field indicate no) while using rounding-mode controls at the same time; 2) be able to use upconversion, swizzling, swap, and/or downconversion; 3) operate on the graphics data type. For instance, upconversion, swizzling, swap, downconversion, and the graphics data type reduce the number of instructions required when working with sources in a different format; as another example, the ability to allow exceptions provides full IEEE compliance with directed rounding-modes.

Exemplary Specific Vector Friendly Instruction Format

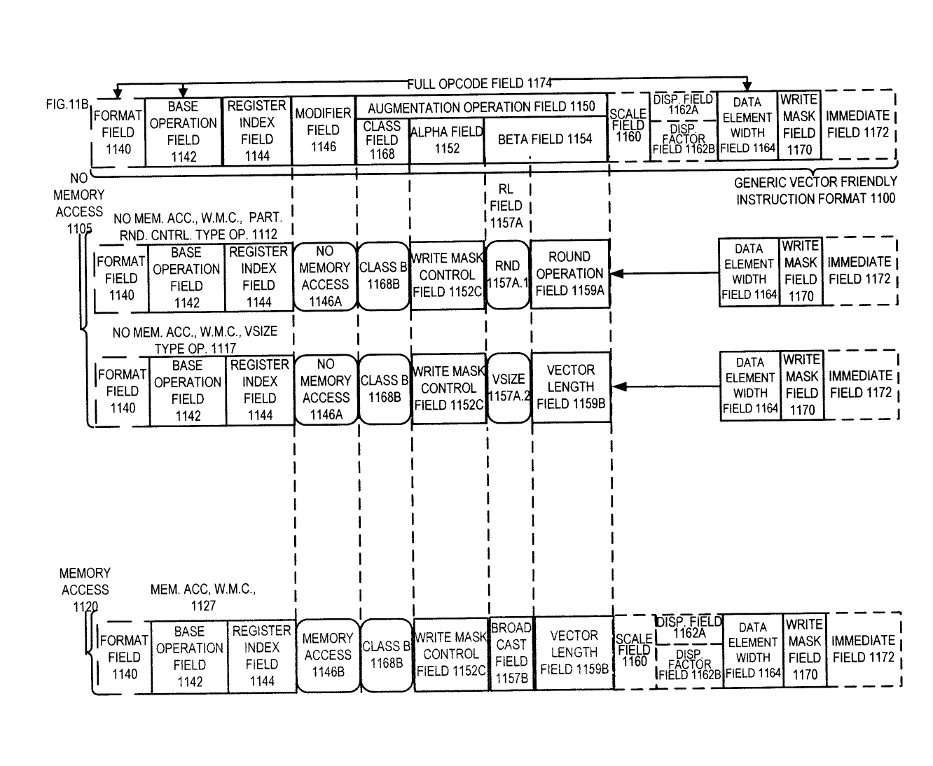

FIG. 12 is a block diagram illustrating an exemplary specific vector friendly instruction format according to embodiments of the invention. FIG. 12 shows a specific vector friendly instruction format 1200 that is specific in the sense that it specifies the location, size, interpretation, and order of the fields, as well as values for some of those fields. The specific vector friendly instruction format 1200 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 11 into which the fields from FIG. 12 map are illustrated.

It should be understand that although embodiments of the invention are described with reference to the specific vector friendly instruction format 1200 in the context of the generic vector friendly instruction format 1100 for illustrative purposes, the invention is not limited to the specific vector friendly instruction format 1200 except where claimed. For example, the generic vector friendly instruction format 1100 contemplates a variety of possible sizes for the various fields, while the specific vector friendly instruction format 1200 is shown as having fields of specific sizes. By way of specific example, while the data element width field 1164 is illustrated as a one bit field in the specific vector friendly instruction format 1200, the invention is not so limited (that is, the generic vector friendly instruction format 1100 contemplates other sizes of the data element width field 1164).

Format—FIG. 12

The generic vector friendly instruction format 1100 includes the following fields listed below in the order illustrated in FIG. 12.

EVEX Prefix (Bytes 0-3)

EVEX Prefix 1202—is encoded in a four-byte form.

Format Field 1140 (EVEX Byte 0, bits [7:0])—the first byte (EVEX Byte 0) is the format field 1140 and it contains 0x62 (the unique value used for distinguishing the vector friendly instruction format in one embodiment of the invention).

The second-fourth bytes (EVEX Bytes 1-3) include a number of bit fields providing specific capability.

REX field 1205 (EVEX Byte 1, bits [7-5])—consists of a EVEX.R bit field (EVEX Byte 1, bit [7]—R), EVEX.X bit field (EVEX byte 1, bit [6]—X), and 1157BEX byte 1, bit[5]—B). The EVEX.R, EVEX.X, and EVEX.B bit fields provide the same functionality as the corresponding VEX bit fields, and are encoded using 1s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 1210—this is the first part of the REX′ field 1210 and is the EVEX.R′ bit field (EVEX Byte 1, bit [4]—R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 1215 (EVEX byte 1, bits [3:0]—mmmm)—its content encodes an implied leading opcode byte (OF, OF 38, or OF 3).

Data element width field 1164 (EVEX byte 2, bit [7]—W)—is represented by the notation EVEX.W. EVEX.W is used to define the granularity (size) of the datatype (either 32-bit data elements or 64-bit data elements).

EVEX.vvvv 1220 (EVEX Byte 2, bits [6:3]—vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 1220 encodes the 4 low-order bits of the first source register specifier stored in inverted (1s complement) form. Depending on the instruction, an extra different EVEX bit field is used to extend the specifier size to 32 registers.

EVEX.U 1168 Class field (EVEX byte 2, bit [2]-U)—If EVEX.U=0, it indicates class A or EVEX.U0; if EVEX.U=1, it indicates class B or EVEX.U1.

Prefix encoding field 1225 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 1152 (EVEX byte 3, bit [7]—EH; also known as EVEX.EH, EVEX.rs, EVEX.RL, EVEX.write mask control, and EVEX.N; also illustrated with a)—as previously described, this field is context specific. Additional description is provided later herein.

Beta field 1154 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific. Additional description is provided later herein.

REX′ field 1210—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 1170 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 1230 (Byte 4)

This is also known as the opcode byte. Part of the opcode is specified in this field.

MOD R/M Field 1240 (Byte 5)

Modifier field 1146 (MODR/M.MOD, bits [7-6]—MOD field 1242)—As previously described, the MOD field's 1242 content distinguishes between memory access and non-memory access operations. This field will be further described later herein.

MODR/M.reg field 1244, bits [5-3]—the role of ModR/M.reg field can be summarized to two situations: ModR/M.reg encodes either the destination register operand or a source register operand, or ModR/M.reg is treated as an opcode extension and not used to encode any instruction operand.

MODR/M.r/m field 1246, bits [2-0]—The role of ModR/M.r/m field may include the following: ModR/M.r/m encodes the instruction operand that references a memory address, or ModR/M.r/m encodes either the destination register operand or a source register operand.

Scale, Index, Base (SIB) Byte (Byte 6)

Scale field 1160 (SIB.SS, bits [7-6]—As previously described, the scale field's 1160 content is used for memory address generation. This field will be further described later herein.

SIB.xxx 1254 (bits [5-3] and SIB.bbb 1256 (bits [2-0])—the contents of these fields have been previously referred to with regard to the register indexes Xxxx and Bbbb.

Displacement Byte(s) (Byte 7 or Bytes 7-10)

Displacement field 1162A (Bytes 7-10)—when MOD field 1242 contains 10, bytes 7-10 are the displacement field 1162A, and it works the same as the legacy 32-bit displacement (disp32) and works at byte granularity.

Displacement factor field 1162B (Byte 7)—when MOD field 1242 contains 01, byte 7 is the displacement factor field 1162B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 1162B is a reinterpretation of disp8; when using displacement factor field 1162B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 1162B substitutes the legacy x86 instruction set 8-bit displacement. Thus, the displacement factor field 1162B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate

Immediate field 1172 operates as previously described.

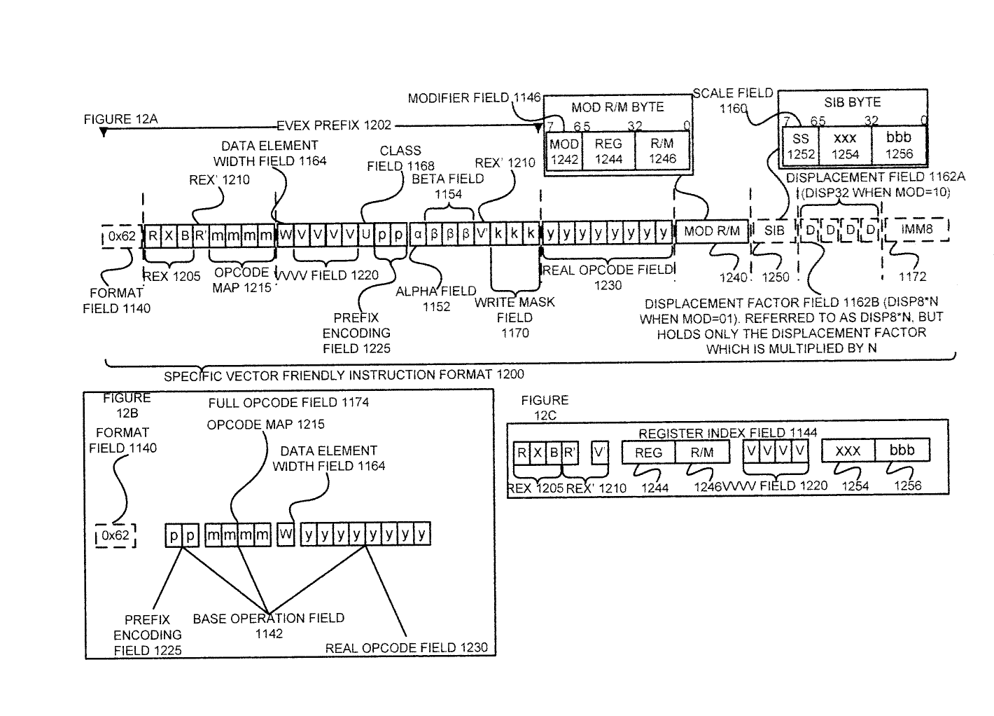

Exemplary Register Architecture—FIG. 13

FIG. 13 is a block diagram of a register architecture 1300 according to one embodiment of the invention. The register files and registers of the register architecture are listed below:

Vector register file 1310—in the embodiment illustrated, there are 32 vector registers that are 1312 bits wide; these registers are referenced as zmm0 through zmm31. The lower order 1156 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1200 operates on these overlaid register file as illustrated in the below tables.

| Adjustable | | | |
|---|---|---|---|
| Vector Length | Class | Operations | Registers |
| Instruction | A (FIG. 11A; | 1110, 1115, | zmm registers |
| Templates that | U = 0) | 1125, 1130 | (the vector |
| do not include | | | length is 64 byte) |
| the vector length | B (FIG. 11B; | 1112 | zmm registers |
| field 1159B | U = 1) | | (the vector |
| | | | length is 64 byte) |
| Instruction | B (FIG. 11B; | 1117, 1127 | zmm, ymm, or |
| Templates that | U = 1) | | xmm registers |
| do include the | | | (the vector |
| vector length | | | length is 64 byte, |
| field 1159B | | | 32 byte, or 16 |
| | | | byte) depending |
| | | | on the vector |
| | | | length field |
| | | | 1159B |

In other words, the vector length field 1159B selects between a maximum length and one or more other shorter lengths, where each such shorter length is half the length of the preceding length; and instructions templates without the vector length field 1159B operate on the maximum vector length. Further, in one embodiment, the class B instruction templates of the specific vector friendly instruction format 1200 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1315—in the embodiment illustrated, there are 8 write mask registers (k0 through k7), each 64 bits in size. As previously described, in one embodiment of the invention the vector mask register k0 cannot be used as a write mask; when the encoding that would normally indicate k0 is used for a write mask, it selects a hardwired write mask of 0xFFFF, effectively disabling write masking for that instruction.

Multimedia Extensions Control Status Register (MXCSR) 1320—in the embodiment illustrated, this 32-bit register provides status and control bits used in floating-point operations.

General-purpose registers 1325—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Extended flags (EFLAGS) register 1330—in the embodiment illustrated, this 32 bit register is used to record the results of many instructions.

Floating Point Control Word (FCW) register 1335 and Floating Point Status Word (FSW) register 1340—in the embodiment illustrated, these registers are used by x87 instruction set extensions to set rounding modes, exception masks and flags in the case of the FCW, and to keep track of exceptions in the case of the FSW.

Scalar floating point stack register file (x87 stack) 1345 on which is aliased the MMX packed integer flat register file 1350—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Segment registers 1355—in the illustrated embodiment, there are six 16 bit registers use to store data used for segmented address generation.

RIP register 1365—in the illustrated embodiment, this 64 bit register that stores the instruction pointer.

Alternative embodiments of the invention may use wider or narrower registers. Additionally, alternative embodiments of the invention may use more, less, or different register files and registers.

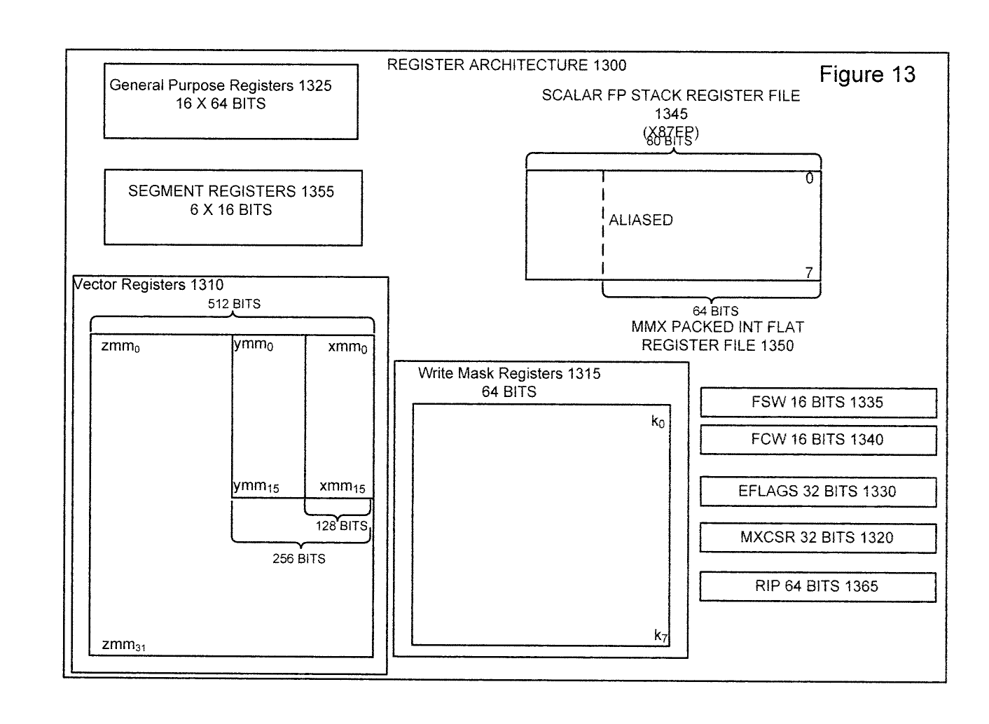

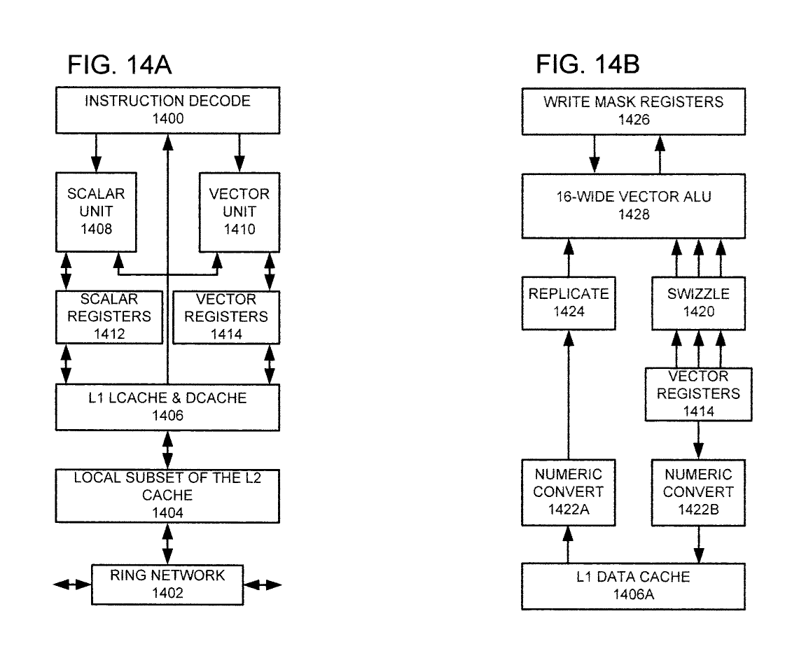

Exemplary In-Order Processor Architecture—FIGS. 14A-14B

FIGS. 14A-B illustrate a block diagram of an exemplary in-order processor architecture. These exemplary embodiments are designed around multiple instantiations of an in-order CPU core that is augmented with a wide vector processor (VPU). Cores communicate through a high-bandwidth interconnect network with some fixed function logic, memory I/O interfaces, and other necessary I/O logic, depending on the e16t application. For example, an implementation of this embodiment as a stand-alone GPU would typically include a PCIe bus.

FIG. 14A is a block diagram of a single CPU core, along with its connection to the on-die interconnect network 1402 and with its local subset of the level 2 (L2) cache 1404, according to embodiments of the invention. An instruction decoder 1400 supports the x86 instruction set with an extension including the specific vector instruction format 1200. While in one embodiment of the invention (to simplify the design) a scalar unit 1408 and a vector unit 1410 use separate register sets (respectively, scalar registers 1412 and vector registers 1414) and data transferred between them is written to memory and then read back in from a level 1 (L1) cache 1406, alternative embodiments of the invention may use a different approach (e.g., use a single register set or include a communication path that allow data to be transferred between the two register files without being written and read back).

The L1 cache 1406 allows low-latency accesses to cache memory into the scalar and vector units. Together with load-op instructions in the vector friendly instruction format, this means that the L1 cache 1406 can be treated somewhat like an extended register file. This significantly improves the performance of many algorithms, especially with the eviction hint field 1152B.

The local subset of the L2 cache 1404 is part of a global L2 cache that is divided into separate local subsets, one per CPU core. Each CPU has a direct access path to its own local subset of the L2 cache 1404. Data read by a CPU core is stored in its L2 cache subset 1404 and can be accessed quickly, in parallel with other CPUs accessing their own local L2 cache subsets. Data written by a CPU core is stored in its own L2 cache subset 1404 and is flushed from other subsets, if necessary. The ring network ensures coherency for shared data.

FIG. 14B is an exploded view of part of the CPU core in FIG. 14A according to embodiments of the invention. FIG. 14B includes an L1 data cache 1406A part of the L1 cache 1404, as well as more detail regarding the vector unit 1410 and the vector registers 1414. Specifically, the vector unit 1410 is a 16-wide vector processing unit (VPU) (see the 16-wide ALU 1428), which executes integer, single-precision float, and double-precision float instructions. The VPU supports swizzling the register inputs with swizzle unit 1420, numeric conversion with numeric convert units 1422A-B, and replication with replication unit 1424 on the memory input. Write mask registers 1426 allow predicating the resulting vector writes.

Register data can be swizzled in a variety of ways, e.g. to support matrix multiplication. Data from memory can be replicated across the VPU lanes. This is a common operation in both graphics and non-graphics parallel data processing, which significantly increases the cache efficiency.

The ring network is bi-directional to allow agents such as CPU cores, L2 caches and other logic blocks to communicate with each other within the chip. Each ring data-path is 1312-bits wide per direction.

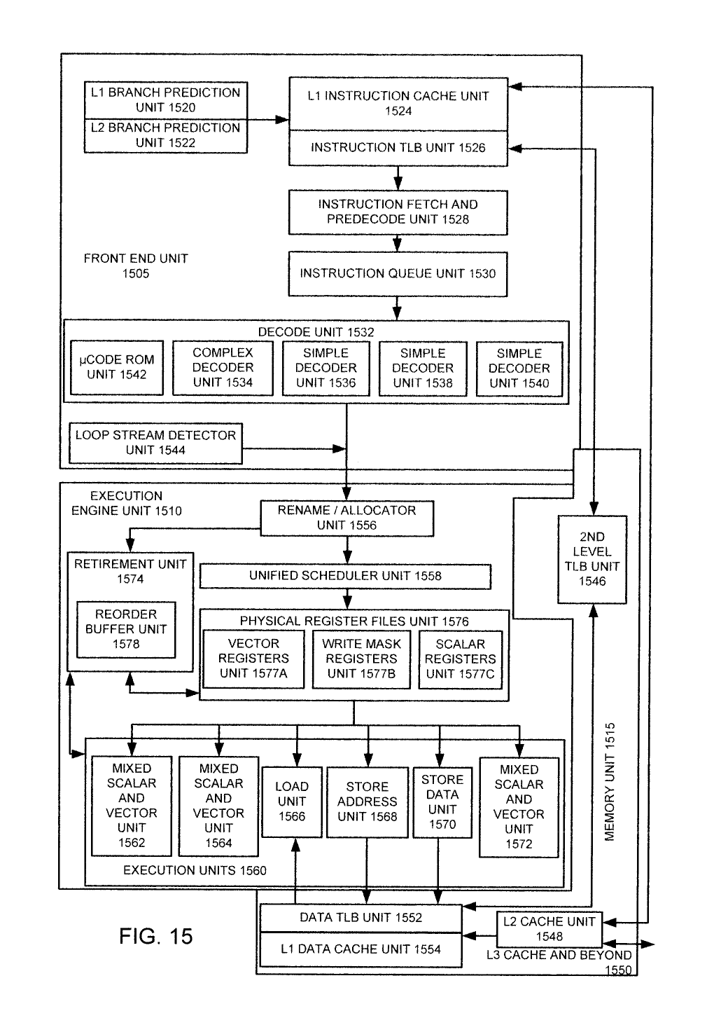

Exemplary Out-of-order Architecture—FIG. 15

FIG. 15 is a block diagram illustrating an exemplary out-of-order architecture according to embodiments of the invention. Specifically, FIG. 15 illustrates a well-known exemplary out-of-order architecture that has been modified to incorporate the vector friendly instruction format and execution thereof. In FIG. 15 arrows denotes a coupling between two or more units and the direction of the arrow indicates a direction of data flow between those units. FIG. 15 includes a front end unit 1505 coupled to an execution engine unit 1510 and a memory unit 1515; the execution engine unit 1510 is further coupled to the memory unit 1515.

The front end unit 1505 includes a level 1 (L1) branch prediction unit 1520 coupled to a level 2 (L2) branch prediction unit 1522. The L1 and L2 brand prediction units 1520 and 1522 are coupled to an L1 instruction cache unit 1524. The L1 instruction cache unit 1524 is coupled to an instruction translation lookaside buffer (TLB) 1526 which is further coupled to an instruction fetch and predecode unit 1528. The instruction fetch and predecode unit 1528 is coupled to an instruction queue unit 1530 which is further coupled a decode unit 1532. The decode unit 1532 comprises a complex decoder unit 1534 and three simple decoder units 1536, 1538, and 1540. The decode unit 1532 includes a micro-code ROM unit 1542. The decode unit 1532 may operate as previously described above in the decode stage section. The L1 instruction cache unit 1524 is further coupled to an L2 cache unit 1548 in the memory unit 1515. The instruction TLB unit 1526 is further coupled to a second level TLB unit 1546 in the memory unit 1515. The decode unit 1532, the micro-code ROM unit 1542, and a loop stream detector unit 1544 are each coupled to a rename/allocator unit 1556 in the execution engine unit 1510.

The execution engine unit 1510 includes the rename/allocator unit 1556 that is coupled to a retirement unit 1574 and a unified scheduler unit 1558. The retirement unit 1574 is further coupled to execution units 1560 and includes a reorder buffer unit 1578. The unified scheduler unit 1558 is further coupled to a physical register files unit 1576 which is coupled to the execution units 1560. The physical register files unit 1576 comprises a vector registers unit 1577A, a write mask registers unit 1577B, and a scalar registers unit 1577C; these register units may provide the vector registers 1310, the vector mask registers 1315, and the general purpose registers 1325; and the physical register files unit 1576 may include additional register files not shown (e.g., the scalar floating point stack register file 1345 aliased on the MMX packed integer flat register file 1350). The execution units 1560 include three mixed scalar and vector units 1562, 1564, and 1572; a load unit 1566; a store address unit 1568; a store data unit 1570. The load unit 1566, the store address unit 1568, and the store data unit 1570 are each coupled further to a data TLB unit 1552 in the memory unit 1515.

The memory unit 1515 includes the second level TLB unit 1546 which is coupled to the data TLB unit 1552. The data TLB unit 1552 is coupled to an L1 data cache unit 1554. The L1 data cache unit 1554 is further coupled to an L2 cache unit 1548. In some embodiments, the L2 cache unit 1548 is further coupled to L3 and higher cache units 1550 inside and/or outside of the memory unit 1515.

By way of example, the exemplary out-of-order architecture may implement a process pipeline as follows: 1) the instruction fetch and predecode unit 1528 perform the fetch and length decoding stages; 2) the decode unit 1532 performs the decode stage; 3) the rename/allocator unit 1556 performs the allocation stage and renaming stage; 4) the unified scheduler 1558 performs the schedule stage; 5) the physical register files unit 1576, the reorder buffer unit 1578, and the memory unit 1515 perform the register read/memory read stage; the execution units 1560 perform the execute/data transform stage; 6) the memory unit 1515 and the reorder buffer unit 1578 perform the write back/memory write stage; 7) the retirement unit 1574 performs the ROB read stage; 8) various units may be involved in the exception handling stage; and 9) the retirement unit 1574 and the physical register files unit 1576 perform the commit stage.

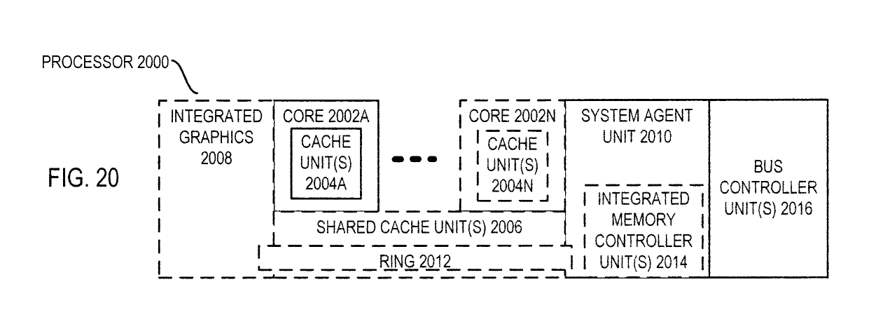

Exemplary Single Core and Multicore Processors—FIG. 20

FIG. 20 is a block diagram of a single core processor and a multicore processor 2000 with integrated memory controller and graphics according to embodiments of the invention. The solid lined boxes in FIG. 119 illustrate a processor 2000 with a single core 2002A, a system agent 2010, a set of one or more bus controller units 2016, while the optional addition of the dashed lined boxes illustrates an alternative processor 2000 with multiple cores 2002A-N, a set of one or more integrated memory controller unit(s) 2014 in the system agent unit 2010, and an integrated graphics logic 2008.

The memory hierarchy includes one or more levels of cache within the cores, a set or one or more shared cache units 2006, and external memory (not shown) coupled to the set of integrated memory controller units 2014. The set of shared cache units 2006 may include one or more mid-level caches, such as level 2 (L2), level 3 (L3), level 4 (L4), or other levels of cache, a last level cache (LLC), and/or combinations thereof. While in one embodiment a ring based interconnect unit 2012 interconnects the integrated graphics logic 2008, the set of shared cache units 2006, and the system agent unit 2010, alternative embodiments may use any number of well-known techniques for interconnecting such units.

In some embodiments, one or more of the cores 2002A-N are capable of multi-threading. The system agent 2010 includes those components coordinating and operating cores 2002A-N. The system agent unit 2010 may include for example a power control unit (PCU) and a display unit. The PCU may be or include logic and components needed for regulating the power state of the cores 2002A-N and the integrated graphics logic 2008. The display unit is for driving one or more externally connected displays.

The cores 2002A-N may be homogenous or heterogeneous in terms of architecture and/or instruction set. For example, some of the cores 2002A-N may be in order (e.g., like that shown in FIGS. 14A and 14B) while others are out-of-order (e.g., like that shown in FIG. 15). As another example, two or more of the cores 2002A-N may be capable of executing the same instruction set, while others may be capable of executing only a subset of that instruction set or a different instruction set. At least one of the cores is capable of executing the vector friendly instruction format described herein.

The processor may be a general-purpose processor, such as a Core™ i3, i5, i7, 2 Duo and Quad, Xeon™, or Itanium™ processor, which are available from Intel Corporation, of Santa Clara, Calif. Alternatively, the processor may be from another company. The processor may be a special-purpose processor, such as, for example, a network or communication processor, compression engine, graphics processor, co-processor, embedded processor, or the like. The processor may be implemented on one or more chips. The processor 2000 may be a part of and/or may be implemented on one or more substrates using any of a number of process technologies, such as, for example, BiCMOS, CMOS, or NMOS.

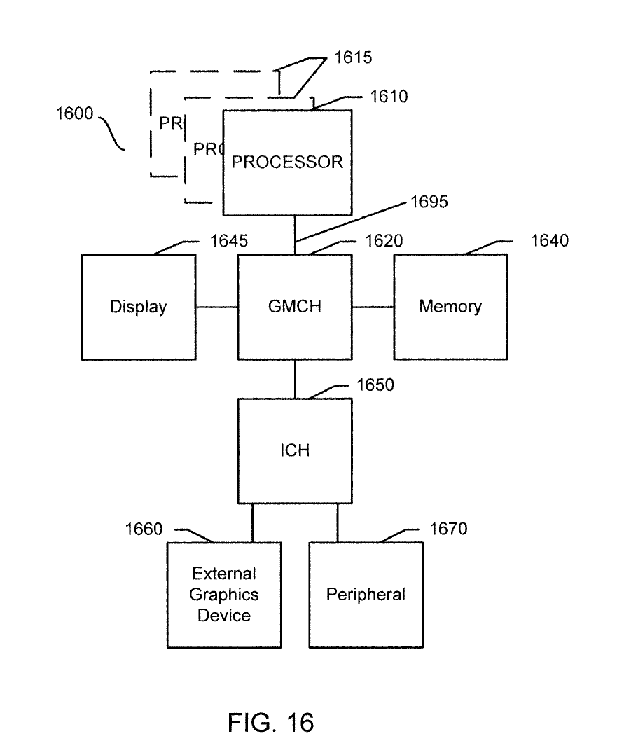

Exemplary Computer Systems and Processors—FIGS. 16-19

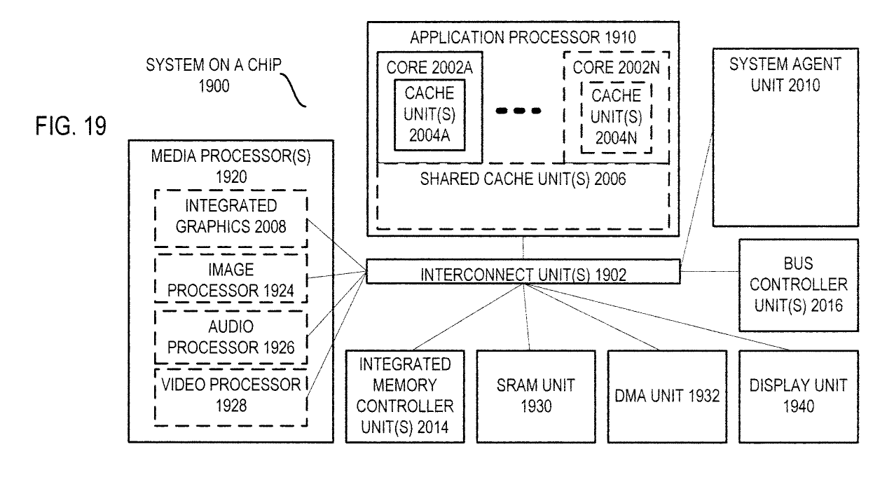

FIGS. 16-18 are exemplary systems suitable for including the processor 2000, while FIG. 19 is an exemplary system on a chip (SoC) that may include one or more of the cores 2002. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 16, shown is a block diagram of a system 1600 in accordance with one embodiment of the invention. The system 1600 may include one or more processors 1610, 1615, which are coupled to graphics memory controller hub (GMCH) 1620. The optional nature of additional processors 1615 is denoted in FIG. 16 with broken lines.

Each processor 1610, 1615 may be some version of processor 2000. However, it should be noted that it is unlikely that integrated graphics logic and integrated memory control units would exist in the processors 1610, 1615.

FIG. 16 illustrates that the GMCH 1620 may be coupled to a memory 1640 that may be, for example, a dynamic random access memory (DRAM). The DRAM may, for at least one embodiment, be associated with a non-volatile cache.

The GMCH 1620 may be a chipset, or a portion of a chipset. The GMCH 1620 may communicate with the processor(s) 1610, 1615 and control interaction between the processor(s) 1610, 1615 and memory 1640. The GMCH 1620 may also act as an accelerated bus interface between the processor(s) 1610, 1615 and other elements of the system 1600. For at least one embodiment, the GMCH 1620 communicates with the processor(s) 1610, 1615 via a multi-drop bus, such as a frontside bus (FSB) 1695.

Furthermore, GMCH 1620 is coupled to a display 1645 (such as a flat panel display). GMCH 1620 may include an integrated graphics accelerator. GMCH 1620 is further coupled to an input/output (I/O) controller hub (ICH) 1650, which may be used to couple various peripheral devices to system 1600. Shown for example in the embodiment of FIG. 16 is an external graphics device 1660, which may be a discrete graphics device coupled to ICH 1650, along with another peripheral device 1670.

Alternatively, additional or different processors may also be present in the system 1600. For example, additional processor(s) 1615 may include additional processors(s) that are the same as processor 1610, additional processor(s) that are heterogeneous or asymmetric to processor 1610, accelerators (such as, e.g., graphics accelerators or digital signal processing (DSP) units), field programmable gate arrays, or any other processor. There can be a variety of differences between the physical resources 1610, 1615 in terms of a spectrum of metrics of merit including architectural, microarchitectural, thermal, power consumption characteristics, and the like. These differences may effectively manifest themselves as asymmetry and heterogeneity amongst the processing elements 1610, 1615. For at least one embodiment, the various processing elements 1610, 1615 may reside in the same die package.

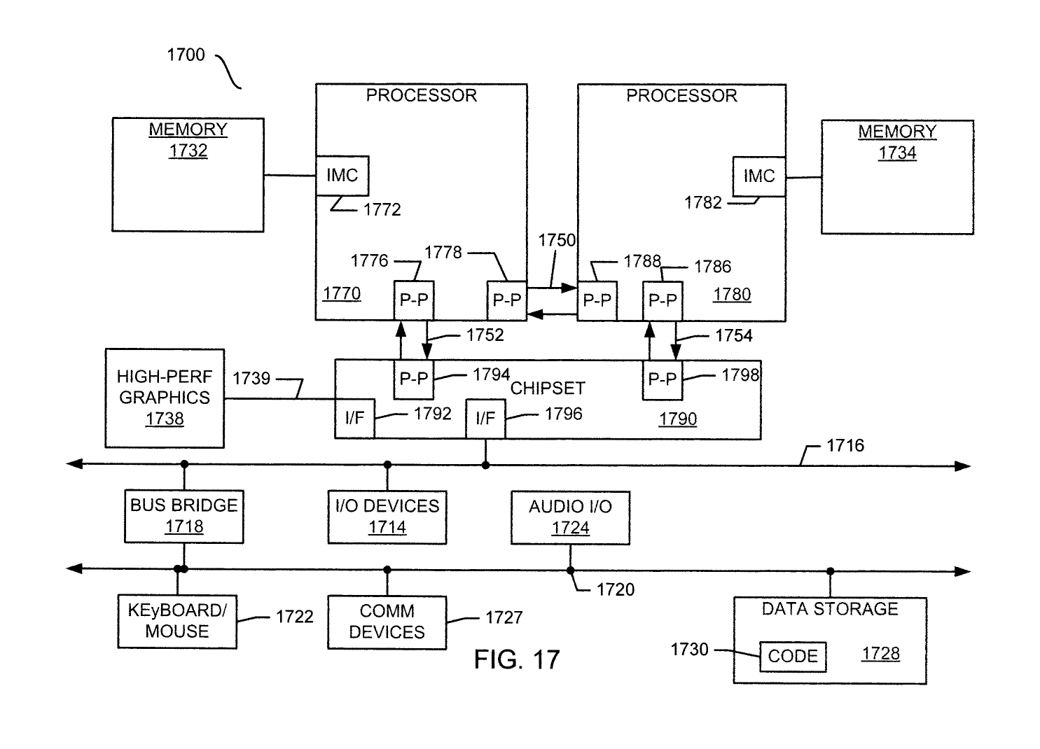

Referring now to FIG. 17, shown is a block diagram of a second system 1700 in accordance with an embodiment of the present invention. As shown in FIG. 17, multiprocessor system 1700 is a point-to-point interconnect system, and includes a first processor 1770 and a second processor 1780 coupled via a point-to-point interconnect 1750. As shown in FIG. 17, each of processors 1770 and 1780 may be some version of the processor 2000.

Alternatively, one or more of processors 1770, 1780 may be an element other than a processor, such as an accelerator or a field programmable gate array.

While shown with only two processors 1770, 1780, it is to be understood that the scope of the present invention is not so limited. In other embodiments, one or more additional processing elements may be present in a given processor.

Processor 1770 may further include an integrated memory controller hub (IMC) 1772 and point-to-point (P-P) interfaces 1776 and 1778. Similarly, second processor 1780 may include a IMC 1782 and P-P interfaces 1786 and 1788. Processors 1770, 1780 may exchange data via a point-to-point (PtP) interface 1750 using PtP interface circuits 1778, 1788. As shown in FIG. 17, IMC's 1772 and 1782 couple the processors to respective memories, namely a memory 1742 and a memory 1744, which may be portions of main memory locally attached to the respective processors.

Processors 1770, 1780 may each exchange data with a chipset 1790 via individual P-P interfaces 1752, 1754 using point to point interface circuits 1776, 1794, 1786, 1798. Chipset 1790 may also exchange data with a high-performance graphics circuit 1738 via a high-performance graphics interface 1739.

A shared cache (not shown) may be included in either processor outside of both processors, yet connected with the processors via P-P interconnect, such that either or both processors' local cache information may be stored in the shared cache if a processor is placed into a low power mode.

Chipset 1790 may be coupled to a first bus 1716 via an interface 1796. In one embodiment, first bus 1716 may be a Peripheral Component Interconnect (PCI) bus, or a bus such as a PCI Express bus or another third generation I/O interconnect bus, although the scope of the present invention is not so limited.

As shown in FIG. 17, various I/O devices 1714 may be coupled to first bus 1716, along with a bus bridge 1718 which couples first bus 1716 to a second bus 1720. In one embodiment, second bus 1720 may be a low pin count (LPC) bus. Various devices may be coupled to second bus 1720 including, for example, a keyboard/mouse 1722, communication devices 1726 and a data storage unit 1728 such as a disk drive or other mass storage device which may include code 1730, in one embodiment. Further, an audio I/O 1724 may be coupled to second bus 1720. Note that other architectures are possible. For example, instead of the point-to-point architecture of FIG. 17, a system may implement a multi-drop bus or other such architecture.

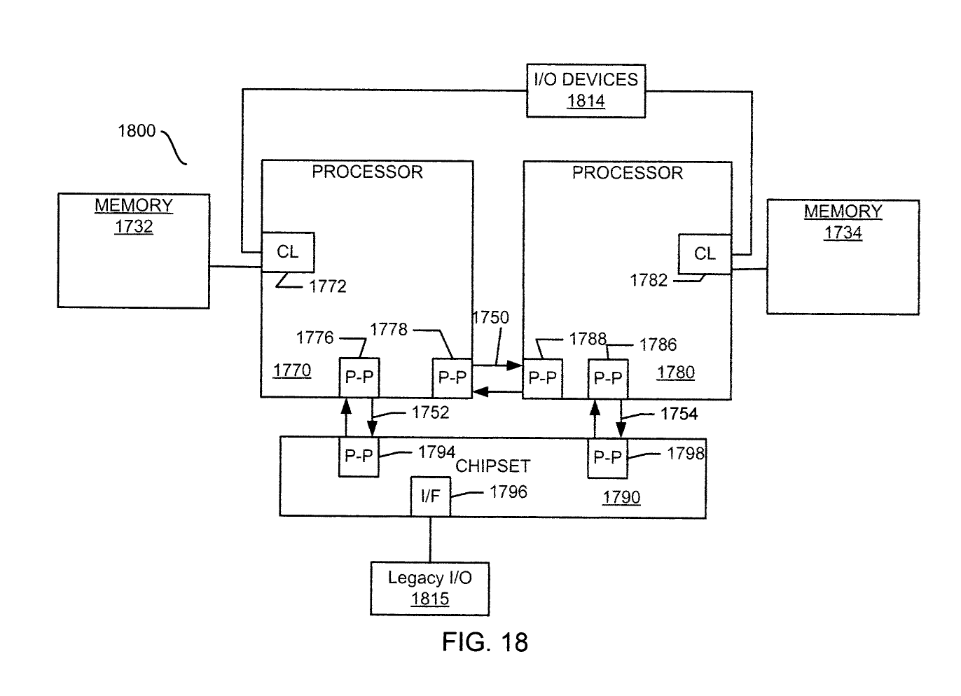

Referring now to FIG. 18, shown is a block diagram of a third system 1800 in accordance with an embodiment of the present invention. Like elements in FIGS. 17 and 18 bear like reference numerals, and certain aspects of FIG. 17 have been omitted from FIG. 18 in order to avoid obscuring other aspects of FIG. 18.

FIG. 18 illustrates that the processing elements 1770, 1780 may include integrated memory and I/O control logic (“CL”) 1772 and 1782, respectively. For at least one embodiment, the CL 1772, 1782 may include memory controller hub logic (IMC) such as that described above in connection with FIGS. 119 and 17. In addition. CL 1772, 1782 may also include I/O control logic. FIG. 18 illustrates that not only are the memories 1742, 1744 coupled to the CL 1772, 1782, but also that I/O devices 1814 are also coupled to the control logic 1772, 1782. Legacy I/O devices 1815 are coupled to the chipset 1790.

Referring now to FIG. 19, shown is a block diagram of a SoC 1900 in accordance with an embodiment of the present invention. Similar elements in FIG. 119 bear like reference numerals. Also, dashed lined boxes are optional features on more advanced SoCs. In FIG. 19, an interconnect unit(s) 1902 is coupled to: an application processor 1910 which includes a set of one or more cores 2002A-N and shared cache unit(s) 2006; a system agent unit 2010; a bus controller unit(s) 2016; an integrated memory controller unit(s) 2014; a set or one or more media processors 1920 which may include integrated graphics logic 2008, an image processor 1924 for providing still and/or video camera functionality, an audio processor 1926 for providing hardware audio acceleration, and a video processor 1928 for providing video encode/decode acceleration; an static random access memory (SRAM) unit 1930; a direct memory access (DMA) unit 1932; and a display unit 1940 for coupling to one or more external displays.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks (compact disk read-only memories (CD-ROMs), compact disk rewritables (CD-RWs)), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions the vector friendly instruction format or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

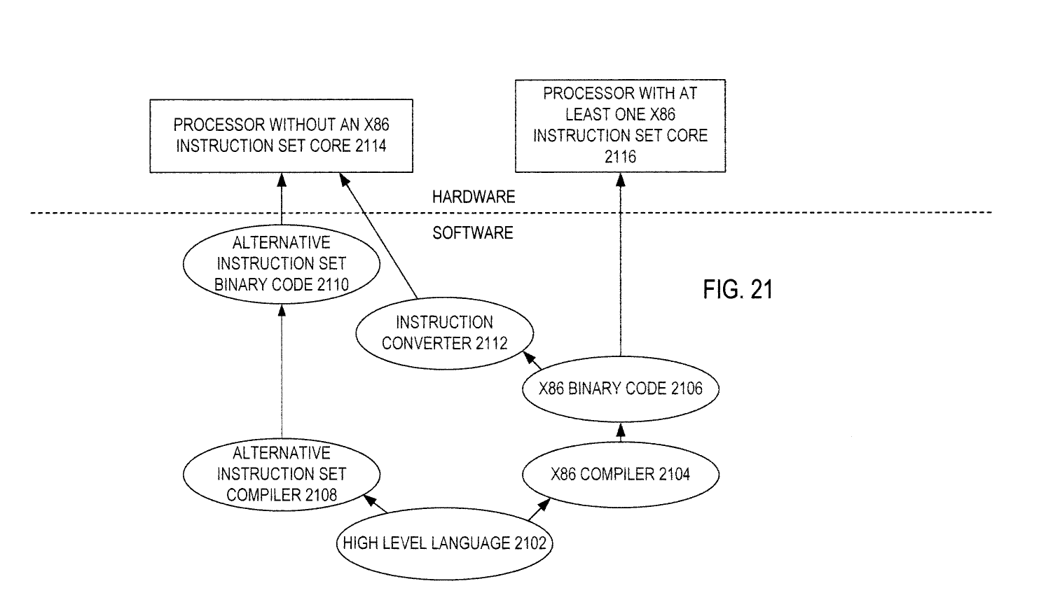

FIG. 21 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 21 shows a program in a high level language 2102 may be compiled using an x86 compiler 2104 to generate x86 binary code 2106 that may be natively executed by a processor with at least one x86 instruction set core 2116 (it is assume that some of the instructions that were compiled are in the vector friendly instruction format). The processor with at least one x86 instruction set core 2116 represents any processor that can perform substantially the same functions as a Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 2104 represents a compiler that is operable to generate x86 binary code 2106 (e.g., object code) that can, with or without additional linkage processing, be executed on the processor with at least one x86 instruction set core 2116. Similarly, FIG. 21 shows the program in the high level language 2102 may be compiled using an alternative instruction set compiler 2108 to generate alternative instruction set binary code 2110 that may be natively executed by a processor without at least one x86 instruction set core 2114 (e.g., a processor with cores that execute the MIPS instruction set of MIPS Technologies of Sunnyvale, Calif. and/or that execute the ARM instruction set of ARM Holdings of Sunnyvale, Calif.). The instruction converter 2112 is used to convert the x86 binary code 2106 into code that may be natively executed by the processor without an x86 instruction set core 2114. This converted code is not likely to be the same as the alternative instruction set binary code 2110 because an instruction converter capable of this is difficult to make; however, the converted code will accomplish the general operation and be made up of instructions from the alternative instruction set. Thus, the instruction converter 2112 represents software, firmware, hardware, or a combination thereof that, through emulation, simulation or any other process, allows a processor or other electronic device that does not have an x86 instruction set processor or core to execute the x86 binary code 2106.

Certain operations of the instruction(s) in the vector friendly instruction format disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 16-19 and embodiments of the instruction(s) in the vector friendly instruction format may be stored in program code to be executed in the systems. Additionally, the processing elements of these figures may utilize one of the detailed pipelines and/or architectures (e.g., the in-order and out-of-order architectures) detailed herein. For example, the decode unit of the in-order architecture may decode the instruction(s), pass the decoded instruction to a vector or scalar unit, etc.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents. For example, one or more operations of a method may be combined or further broken apart.

### Alternative Embodiments

While embodiments have been described which would natively execute the vector friendly instruction format, alternative embodiments of the invention may execute the vector friendly instruction format through an emulation layer running on a processor that executes a different instruction set (e.g., a processor that executes the MIPS instruction set of MIPS Technologies of Sunnyvale, Calif., a processor that executes the ARM instruction set of ARM Holdings of Sunnyvale, Calif.). Also, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below.

What is claimed is:

1. A method of performing a compress instruction in a computer processor, comprising:
fetching the compress instruction, wherein the compress instruction includes a destination operand, a source operand, and a writemask operand;
decoding the fetched compress instruction;
executing the decoded compress instruction to select which data elements from the source are to be stored in the destination based on values of the writemask; and
storing the selected data elements of the source as sequentially packed data elements into the destination.

2. The method of claim 1, wherein the destination operand is memory and the source operand is a register.

3. The method of claim 1, wherein the source and destination operand are registers.

4. The method of claim 1, wherein the executing further comprises:
determining that a first bit position value of the writemask indicates that the corresponding first source data element should be stored into a location of the destination; and
storing the corresponding first source data element into the location of the destination.

5. The method of claim 1, wherein the executing further comprises:
determining that a first bit position value of the writemask indicates that the corresponding first source data element should not be stored into a location of the destination; and
evaluating a second bit position value of the writemask without storing the first source data element into a location of the destination.

6. The method of claim 1, wherein each source data element to be stored into the destination is first placed into a stream and the stream is stored into the destination.

7. The method of claim 1, further comprising:
downconverting the data elements to be stored into the destination prior to storing them into the destination.

8. The method of claim 7, wherein the data elements are downconverted from 32-bit values to 16-bit values.

9. A method of performing an expand instruction in a computer processor, comprising:
fetching the expand instruction, wherein the expand instruction includes a destination operand, a source operand, and a writemask operand;
decoding the expand compress instruction;
executing the expand compress instruction to select which elements from the source are to be sparsely stored in the destination based on values of the writemask; and
storing each selected data element of the source as a sparse data element into a destination location, wherein the destination locations correspond to each writemask bit position that indicates that the corresponding data element of the source is to be stored.

10. The method of claim 9, wherein the destination operand is a register and the source operand is memory.

11. The method of claim 9, wherein the source and destination operand are registers.

12. The method of claim 9, wherein the executing further comprises:
determining that a first bit position value of the writemask indicates that the corresponding first source data element should be stored into a corresponding location of the destination; and
storing the corresponding first source data element into the corresponding location of the destination.

13. The method of claim 9, wherein the executing further comprises:
determining that a first bit position value of the writemask indicates that the corresponding first source data element should not be stored into a corresponding location of the destination; and
evaluating a second bit position value of the writemask without storing the first source data element into a corresponding location of the destination.

14. The method of claim 1, wherein each source data element to be stored into the destination is first placed into a stream and the stream is stored into the destination.

15. The method of claim 1, further comprising:
upconverting the data elements to be stored into the destination prior to storing them into the destination.

16. The method of claim 7, wherein the data elements are upconverted from 16-bit values to 32-bit values.

17. An apparatus comprising;
a hardware decoder to decode an expand instruction and/or a compress instruction, wherein the expand instruction includes a first writemask operand, a first destination operand, a first source operand and the compress instruction includes a second writemask operand, a second destination operand, a second source operand; and
execution logic to
execute a decoded expand instruction to select which elements from the source are to be sparsely stored in the destination based on values of the writemask and store each selected data element of the source as a sparse data element into a destination location, wherein the destination locations correspond to each writemask bit position that indicates that the corresponding data element of the source is to be stored, and
execute a decoded compress instruction to select which data elements from the source are to be stored in the destination based on values of the writemask and store the selected data elements of the source as sequentially packed data elements into the destination.

18. The apparatus of claim 17, further comprising:
a 16-bit writemask register to store the first or second writemask; and
a first 512-bit register to store the selected data elements.

19. The apparatus of claim 18, further comprising:
a second 512-bit register to act as a source for the expand and compress instructions.

20. The apparatus of claim 17, wherein the data elements are upconverted from 16-bit values to 32-bit values during the execution of an expand instruction.
